(19) United States
(12) Patent Application Publication
(10) Pub. No.: US 2018/0352248 A1
(43) Pub. Date: Dec. 6, 2018

(54) IMAGE DECODING METHOD, IMAGE ENCODING METHOD, IMAGE DECODING DEVICE, IMAGE ENCODING DEVICE, AND IMAGE ENCODING/DECODING DEVICE

(71) Applicant: Panasonic Intellectual Property Corporation of America, Torrance, CA (US)

(72) Inventors: Takahiro NISHI, Nara (JP); Tadamasa TOMA, Osaka (JP); Kengo TERADA, Osaka (JP)

(21) Appl. No.: 15/780,448

(22) PCT Filed: Oct. 19, 2016
(86) PCT No.: PCT/JP2016/004616

§ 371 Date: May 31, 2018

Related U.S. Application Data
(60) Provisional application No. 62/263,113, filed on Dec. 4, 2015.

(30) Foreign Application Priority Data
May 19, 2016 (JP) 2016-100854

(51) Int. Cl. H04N 19/513; H04N 19/23; H04N 19/172; H04N 19/124; H04N 19/176

(52) U.S. Cl. CPC H04N 19/513; H04N 19/23; G06T 7/194; H04N 19/124; H04N 19/176; H04N 19/172

(57) ABSTRACT

An image decoding method includes: obtaining, for each of processing units obtained by splitting a current frame, motion vectors assigned to the processing unit; selecting, for each of small regions obtained by splitting a processing unit among the processing units, a motion vector to be used from among the motion vectors assigned to the processing unit, based on the motion vectors and reference frames at different times; generating, for each of the small regions, a predicted image using the motion vector selected for the small region; and decoding each of the small regions using the predicted image generated for the small region.

### TECHNICAL FIELD

The present disclosure relates to an image decoding method and an image encoding method.

### BACKGROUND ART

In the High Efficiency Video Coding (HEVC) standard which is the latest video encoding standard, various examinations have been made in order to improve encoding efficiency (for example, see Non Patent Literature (NPL) 1). The method is based on the International Telecommunication Union Telecommunication Standardization Sector (ITU-T) standard indicated by H.26x and the International Organization for Standardization/International Electrotechnical Commission (ISO/IEC) standard indicated by MPEG-x, and has been examined as the next image encoding standard subsequent to the standard indicated by H.264/AVC or MPEG-4 AVC.

### CITATION LIST

### Non Patent Literature

NPL 1: ITU-T Recommendation H.265 “High efficiency video coding”, April, 2015

### SUMMARY OF THE INVENTION

There has been a demand for such an image encoding method and an image decoding method to improve encoding efficiency.

An object of the present disclosure is to provide an image decoding method and/or an image encoding method which can improve encoding efficiency.

In order to achieve the above object, an image decoding method according to an aspect of the present disclosure includes: obtaining, for each of processing units obtained by splitting a current frame, motion vectors assigned to the processing unit; selecting, for each of small regions obtained by splitting a processing unit among the processing units, a motion vector to be used from among the motion vectors assigned to the processing unit, based on the motion vectors and reference frames at different times; generating, for each of the small regions, a predicted image using the motion vector selected for the small region; and decoding each of the small regions using the predicted image generated for the small region.

An image encoding method according to an aspect of the present disclosure includes: detecting, for each of processing units obtained by splitting a current frame, motion vectors to be assigned to the processing unit; selecting, for each of small regions obtained by splitting a processing unit among the processing units, a motion vector to be used from among the motion vectors assigned to the processing unit, based on the motion vectors and reference frames at different times; generating, for each of the small regions, a predicted image using the motion vector selected for the small region; and encoding each of the small regions using the predicted image generated for the small region.

These general and specific aspects may be implemented using a system, a method, an integrated circuit, a computer program, or a computer-readable recording medium such as a CD-ROM, or any combination of systems, methods, integrated circuits, computer programs, or recording media.

The present disclosure can provide an image decoding method and/or an image encoding method which can improve encoding efficiency.

### BRIEF DESCRIPTION OF DRAWINGS

FIG. 1 is a diagram illustrating a prediction method according to Embodiment 1.

FIG. 2 is a diagram illustrating the prediction method according to Embodiment 1.

FIG. 3 is a diagram illustrating the prediction method according to Embodiment 1.

FIG. 4 is a block diagram of an image encoding device according to Embodiment 1.

FIG. 5 is a flowchart of prediction processing according to Embodiment 1.

FIG. 6 is a diagram illustrating motion detection processing according to Embodiment 1.

FIG. 7 is a diagram illustrating reference block obtaining processing according to Embodiment 1.

FIG. 8 is a diagram illustrating motion vector selection processing according to Embodiment 1.

FIG. 9 is a diagram illustrating processing for an unidentified region according to Embodiment 1.

FIG. 10 is a diagram illustrating the processing for an unidentified region according to Embodiment 1.

FIG. 11 is a diagram illustrating the processing for an unidentified region according to Embodiment 1.

FIG. 12 is a flowchart of processing of selecting a motion vector and reference pixels according to Embodiment 1.

FIG. 13 is a diagram illustrating an example of an encoding structure according to Embodiment 1.

FIG. 14 is a block diagram of an image decoding device according to Embodiment 1.

FIG. 15 is a flowchart of image encoding processing according to Embodiment 1.

FIG. 16 is a flowchart of image decoding processing according to Embodiment 1.

FIG. 17 illustrates an overall configuration of a content providing system for implementing a content distribution service.

FIG. 18 illustrates one example of encoding structure in scalable encoding.

FIG. 19 illustrates one example of encoding structure in scalable encoding.

FIG. 20 illustrates an example of a display screen of a web page.

FIG. 21 illustrates an example of a display screen of a web page.

FIG. 22 illustrates one example of a smartphone.

FIG. 23 is a block diagram illustrating a configuration example of a smartphone.

### DESCRIPTION OF EXEMPLARY EMBODIMENTS

An image decoding method according to an aspect of the present disclosure includes: obtaining, for each of processing units obtained by splitting a current frame, motion vectors assigned to the processing unit; selecting, for each of small regions obtained by splitting a processing unit among the processing units, a motion vector to be used from among the motion vectors assigned to the processing unit, based on the motion vectors and reference frames at different times; generating, for each of the small regions, a predicted image using the motion vector selected for the small region; and decoding each of the small regions using the predicted image generated for the small region.

According to this, an image decoding device can select a motion vector to be used for a small region, from among a plurality of motion vectors associated with a processing unit. This allows different motion vectors to be used for a plurality of small regions included in a processing unit. It is not necessary to include, in an encoded bitstream, information for designating a motion vector for each small region, and thus an increase in the data volume of the encoded bitstream can be inhibited. Thus, the image decoding method improves encoding efficiency.

For example, the reference frames may include a first frame and a second frame, and in selecting the motion vector, a correlation between a region on the first frame and a region on the second frame may be obtained for each of the motion vectors, the region on the first frame and the region on the second frame being indicated by the motion vector from a current small region included in the current frame, and the motion vector to be used may be selected based on the correlations obtained for the motion vectors.

For example, the motion vectors may include a background vector indicating background motion, and a foreground vector indicating foreground motion.

For example, in selecting the motion vector, the background vector may be selected when a correlation between regions indicated by the background vector and a correlation between regions indicated by the foreground vector are each lower than a predetermined value.

According to this, a region covered by a foreground in a reference frame, for instance, can be determined to be a background region, and thus an appropriate motion vector can be selected.

For example, in generating the predicted image, when the correlation between the regions indicated by the background vector and the correlation between the regions indicated by the foreground vector are each lower than the predetermined value, the predicted image may be generated using a region that belongs to a background, among a first region on the first frame and a second region on the second frame, the first region and the second region being indicated by the background vector.

According to this, an appropriate predicted image can be generated also for a region covered by the foreground in a reference frame, for instance.

For example, in generating the predicted image, one of the first region and the second region may be determined to belong to the background when a corresponding point which is a region on the current frame belongs to the background, the corresponding point being indicated by the foreground vector from the one of the first region and the second region.

According to this, it can be appropriately determined whether a region on a reference frame indicated by a background vector is a background region or a foreground region.

For example, in generating the predicted image, when neither the first region nor the second region belongs to the background, a predicted image of a current small region within the current frame may be generated using a predicted image of a region near the current small region.

Accordingly, a predicted image can be generated even in the case where appropriate reference cannot be made.

An image encoding method according to an aspect of the present disclosure includes: detecting, for each of processing units obtained by splitting a current frame, motion vectors to be assigned to the processing unit; selecting, for each of small regions obtained by splitting a processing unit among the processing units, a motion vector to be used from among the motion vectors assigned to the processing unit, based on the motion vectors and reference frames at different times; generating, for each of the small regions, a predicted image using the motion vector selected for the small region; and encoding each of the small regions using the predicted image generated for the small region.

According to this, an image decoding device can select a motion vector to be used for a small region, from among a plurality of motion vectors associated with a processing unit. This allows different motion vectors to be used for a plurality of small regions included in a processing unit. It is not necessary to include, in an encoded bitstream, information for designating a motion vector for each small region, and thus an increase in the data volume of the encoded bitstream can be inhibited. Thus, the image encoding method improves encoding efficiency.

For example, the reference frames may include a first frame and a second frame, and in selecting the motion vector, a correlation between a region on the first frame and a region on the second frame may be obtained for each of the motion vectors, the region on the first frame and the region on the second frame being indicated by the motion vector from a current small region included in the current frame, and the motion vector to be used may be selected based on the correlations obtained for the motion vectors.

For example, the motion vectors may include a background vector indicating background motion, and a foreground vector indicating foreground motion.

For example, in selecting the motion vector, the background vector may be selected when a correlation between regions indicated by the background vector and a correlation between regions indicated by the foreground vector are each lower than a predetermined value.

According to this, a region covered by a foreground in a reference frame, for instance, can be determined to be a background region, and thus an appropriate motion vector can be selected.

For example, in generating the predicted image, when the correlation between the regions indicated by the background vector and the correlation between the regions indicated by the foreground vector are each lower than the predetermined value, the predicted image may be generated using a region that belongs to a background, among a first region on the first frame and a second region on the second frame, the first region and the second region being indicated by the background vector.

According to this, an appropriate predicted image can be generated also for a region covered by the foreground in a reference frame, for instance.

For example, in generating the predicted image, one of the first region and the second region may be determined to belong to the background when a corresponding point which is a region on the current frame belongs to the background, the corresponding point being indicated by the foreground vector from the one of the first region and the second region.

According to this, it can be appropriately determined whether a region on a reference frame indicated by a background vector is a background region or a foreground region.

For example, when neither the first region nor the second region belongs to the background, a predicted image of a current small region within the current frame may be generated using a predicted image of a region near the current small region.

Accordingly, a predicted image can be generated even in the case where appropriate reference cannot be made.

An image decoding device according to an aspect of the present disclosure includes: processing circuitry; and storage accessible from the processing circuitry, wherein the processing circuitry performs the image decoding method, using the storage.

An image decoding device according to an aspect of the present disclosure includes: an obtainer which obtains, for each of processing units obtained by splitting a current frame, motion vectors assigned to the processing unit; a selector which selects, for each of small regions obtained by splitting a processing unit among the processing units, a motion vector to be used from among the motion vectors assigned to the processing unit, based on the motion vectors and reference frames at different times; a generator which generates, for each of the small regions, a predicted image using the motion vector selected for the small region; and a decoder which decodes each of the small regions using the predicted image generated for the small region.

An image encoding device according to an aspect of the present disclosure includes: processing circuitry; and storage accessible from the processing circuitry, wherein the processing circuitry performs the image encoding method, using the storage.

An image encoding device according to an aspect of the present disclosure includes: a detector which detects, for each of processing units obtained by splitting a current frame, motion vectors to be assigned to the processing unit; a selector which selects, for each of small regions obtained by splitting a processing unit among the processing units, a motion vector to be used from among the motion vectors assigned to the processing unit, based on the motion vectors and reference frames at different times; a generator which generates, for each of the small regions, a predicted image using the motion vector selected for the small region; and an encoder which encodes each of the small regions using the predicted image generated for the small region.

An image encoding/decoding device according to an aspect of the present disclosure includes the image decoding device, and the image encoding device.

Note that these general and specific aspects may be implemented using a system, a method, an integrated circuit, a computer program, or a computer-readable recording medium such as a CD-ROM, or any combination of systems, methods, integrated circuits, computer programs, or recording media.

The following specifically describes embodiments, with reference to the drawings. Note that the embodiments described below each show a general or specific example. The numerical values, shapes, materials, elements, the arrangement and connection of the elements, steps, and the processing order of the steps, for instance, described in the following embodiments are mere examples, and thus are not intended to limit the present disclosure.

Note that a detailed description of a matter already known well and a redundant description of substantially the same configuration may be omitted. This is intended to avoid making the following description unnecessarily redundant and to facilitate understanding of persons skilled in the art.

In the present embodiment, a frame may be instead stated as a picture or an image. Furthermore, a frame (a picture or an image) or a block to be encoded or decoded may be instead stated as, for instance, a current picture (target picture), a current frame (target frame), or a current block (target block). Such terms are also instead stated as various terms generally used in the codec technical field, other than the above terms.

### Embodiment 1

In the present embodiment, in inter prediction video encoding, based on motion vectors assigned to a predetermined processing unit and reference frames at different times, a motion vector and a reference frame which are to be used in inter prediction are selected for each small region (first sub-block) smaller than the predetermined processing unit on a current frame.

Motion vectors are determined by detecting individual motion of a moving object or a background in a predetermined processing unit at the time of encoding.

Selection of a motion vector and a reference frame is determined based on a correlation of reference pixels on at least two reference frames at different times.

When selecting a motion vector and a reference frame, it is determined, for a region for which a high correlation is not found from reference pixels on at least two reference frames at different times, whether to use the at least two reference frames to predict a small region, using a motion vector of a foreground.

When selecting a motion vector and a reference frame, for a region for which a reference frame is not successfully selected, a predicted value for pixels in the region is determined using a predicted value for neighboring pixels.

First, an outline of a prediction method according to the present embodiment is to be described.

In inter prediction video encoding, an image encoding device (encoder) notifies an image decoding device (decoder) of a plurality of motion vectors for a coding block (a processing unit for prediction processing). Based on correlations between corresponding regions (second sub-blocks) included in reference frames and indicated by motion vectors scaled according to inter-frame distances, the image encoding device and the image decoding device select, for each of small regions in a coding block, a motion vector and a reference frame to be used and make prediction. Examples of the size of a small region and the size of a corresponding region include 4×4, 3×3, and 2×2 pixels. A correlation between corresponding regions is evaluated based on a sum of absolute differences of pixel values in the corresponding regions.

Note that a small region which is a unit for selecting a motion vector and a corresponding region used for determining a correlation may have the same size or different sizes. For example, a corresponding region may include a region having the same size as the small region and a region in the vicinity thereof.

Accordingly, even if a coding block includes different motions of, for instance, a moving object and a background, the image encoding device and the image decoding device can appropriately change, for each small region, a motion vector and a reference frame to be used and make prediction, without the image encoding device notifying the image decoding device of the position of a boundary between the moving object and the background. Accordingly, prediction residual can be reduced without subdividing the coding block. As a result, encoding efficiency improves since overhead for notifying a motion vector and split of a coding block can be reduced while reducing prediction residual.

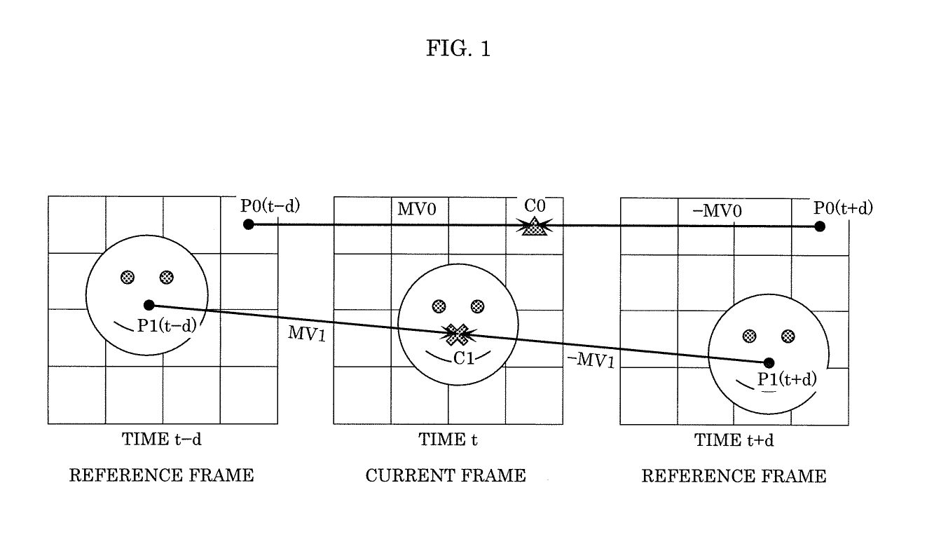

FIG. 1 is a diagram illustrating an example of operation in the case of referring to a total of two reference frames whose display times are before and after the display time of a current frame. Note that in FIGS. 1 to 3, the entire quadrilateral illustrated as a reference frame or a current frame is a processing unit (coding block 122 later described) for prediction processing. Background pixels C0 and foreground pixels C1 correspond to small regions obtained by splitting a coding block, reference pixels P0(t−2d), P0(t−d), P0(t+d), P1(t−2d), P1(t−d), and P1(t+d) correspond to corresponding regions obtained by splitting a coding block.

The image encoding device notifies the image decoding device of two motion vectors MV0 and MV1. The image encoding device and the image decoding device select, for background pixels C0, motion vector MV0 and reference pixels P0(t−d) and P0(t+d) since a correlation of reference pixels P0(t−d) and P0(t+d) indicated by motion vector MV0 is high.

The image encoding device and the image decoding device select, for foreground pixels C1, motion vector MV1 and reference pixels P1(t−d) and P1(t+d) since a correlation of reference pixels P1(t−d) and P1(t+d) indicated by motion vector MV1 is high.

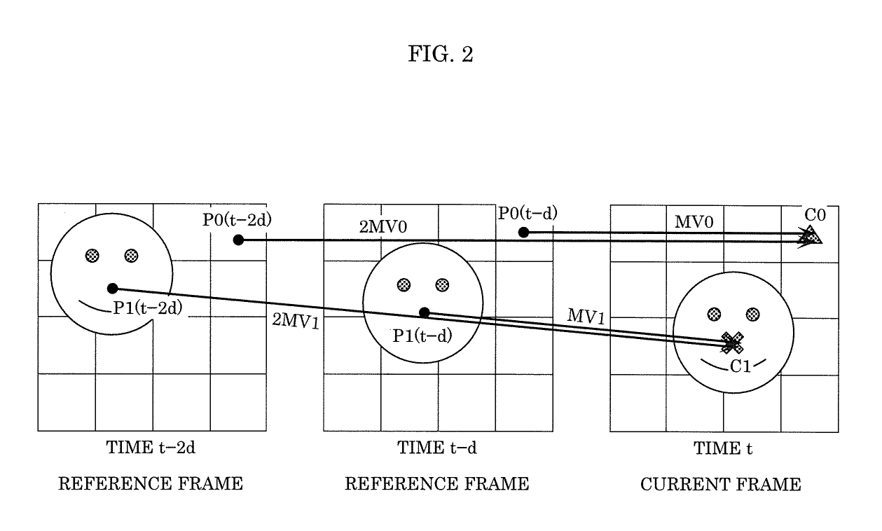

FIG. 2 is a diagram illustrating an example of operation in the case of referring to a total of two reference frames whose display times are only before the display time of a current frame.

The image encoding device notifies the image decoding device of motion vectors MV0 and MV1. The image encoding device and the image decoding device select, for background pixels C0, motion vector MV0 and reference pixels P0(t−d) and P0(t−2d), since a correlation of reference pixels P0(t−d) and P0(t−2d) indicated by motion vector MV0 is high.

The image encoding device and the image decoding device select, for foreground pixels C1, motion vector MV1 and reference pixels P1(t−d) and P1(t−2d) since a correlation of reference pixels P1(t−d) and P1(t−2d) indicated by motion vector MV1 is high.

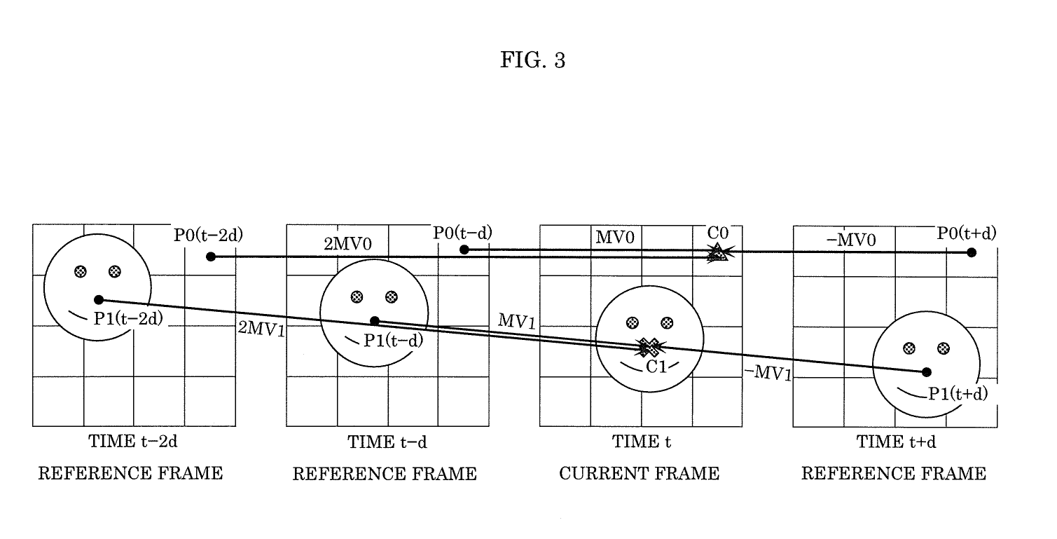

FIG. 3 is a diagram illustrating an example of operation in the case of referring to a total of three reference frames whose display times are before and after the display time of a current frame.

The image encoding device notifies the image decoding device of motion vectors MV0 and MV1. The image encoding device and the image decoding device select, for background pixels C0, motion vector MV0 and reference pixels P0(t−2d), P0(t−d), and P0(t+d) since a correlation of reference pixels P0(t−2d), P0(t−d), and P0(t+d) indicated by motion vector MV0 is high.

The image encoding device and the image decoding device select, for foreground pixels C1, motion vector MV1 and reference pixels P1(t−2d), P1(t−d), and P1(t+d) since a correlation of reference pixels P1(t−2d), P1(t−d), and P1(t+d) indicated by motion vector MV1 is high.

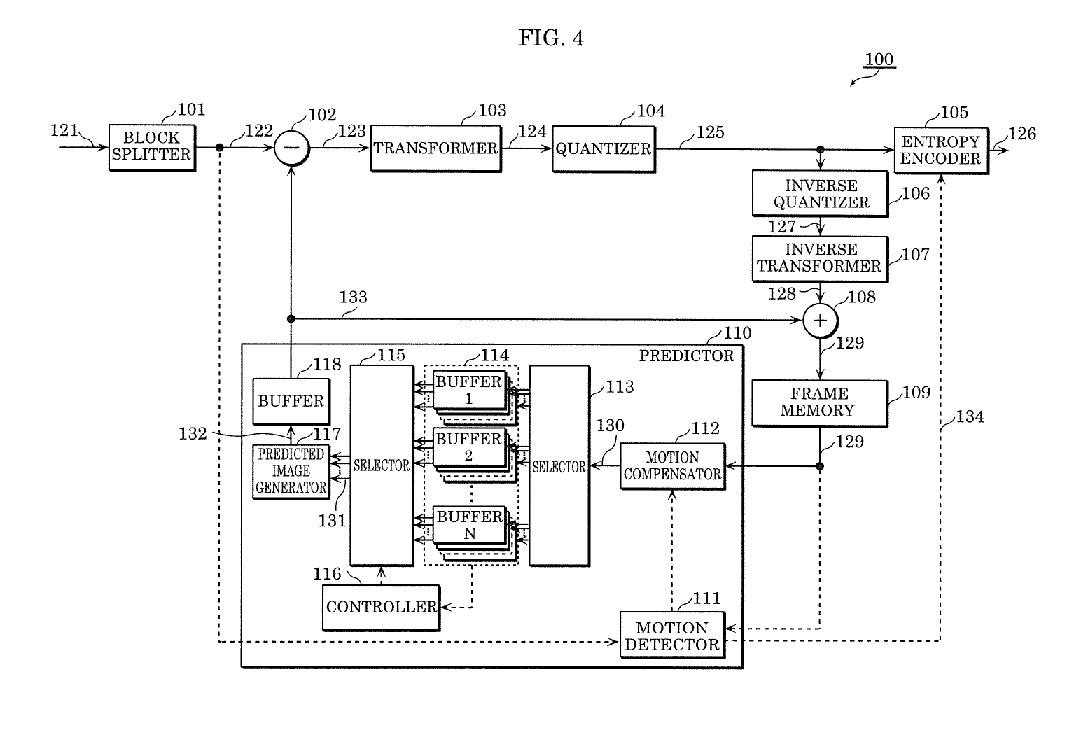

The following describes a configuration of the image encoding device according to the present embodiment. FIG. 4 is a block diagram illustrating an example of a configuration of the image encoding device according to the present embodiment. Image encoding device 100 illustrated in FIG. 4 selects a motion vector and a reference frame which are to be used for prediction made for each small region and performs inter prediction, based on a motion vector and a decoded reference frame which the image decoding device can use. Image encoding device 100 includes block splitter 101, subtractor 102, transformer 103, quantizer 104, entropy encoder 105, inverse quantizer 106, inverse transformer 107, adder 108, frame memory 109, and predictor 110

Block splitter 101 splits input image 121 into a plurality of coding blocks 122 which are encoding processing units. Subtractor 102 generates difference block 123 which is a difference between coding block 122 and predicted block 133. Transformer 103 generates coefficient block 124 by performing frequency transformation on difference block 123. Quantizer 104 generates coefficient block 125 by quantizing coefficient block 124.

Entropy encoder 105 generates bitstream 126 by performing entropy encoding on coefficient block 125. Inverse quantizer 106 generates coefficient block 127 by performing inverse quantization on coefficient block 125, and inverse transformer 107 restores difference block 128 by performing inverse frequency transformation on coefficient block 127. Adder 108 generates decoded block 129 (reconstructed image) by adding difference block 128 and predicted block 133. Decoded block 129 is stored into frame memory 109, and used for prediction processing.

Predictor 110 generates predicted block 133 using decoded block 129. Predictor 110 includes motion detector 111, motion compensator 112, selectors 113 and 115, buffers 114 and 118, controller 116, and predicted image generator 117.

Motion detector 111 detects motion to calculate a motion vector using coding block 122 and decoded block 129. Here, motion detector 111 calculates a plurality of motion vectors (N motion vectors: N is an integer greater than or equal to 2) for one coding block 122. Motion information 134 for identifying such N motion vectors is sent to entropy encoder 105 and encoded. Specifically, encoded bitstream 126 includes motion information 134 for identifying N motion vectors for each coding block 122.

Motion compensator 112 generates a plurality of reference blocks 130 by performing motion compensation using calculated N motion vectors. Specifically, when M reference frames (where M is an integer of 2 or greater) is used, motion compensator 112 generates M reference blocks 130 for each motion vector. Specifically, N×M reference blocks 130 are generated.

A plurality of (N×M) buffers 114 are divided into N buffer groups. N buffer groups are in one-to-one correspondence with N motion vectors. Each buffer group includes M buffers, and M buffers are in one-to-one correspondence with M reference frames. N×M reference blocks 130 generated by motion compensator 112 are temporarily stored into buffers 114 in correspondence, via selector 113.

Controller 116 evaluates, for each small region in coding block 122 and for each motion vector, a correlation of M reference pixels 131 on M reference frames, and selects one motion vector and a plurality of reference frames to be used for prediction. Controller 116 outputs a plurality of reference pixels 131 indicated by motion vectors selected for small regions, to predicted image generator 117 via selector 115. Here, reference pixels 131 constitute an image (pixel values) having the same size as the size of small regions on a plurality of reference frames (reference blocks 130).

Predicted image generator 117 generates, for each small region, predicted image 132 using obtained reference pixels 131. For example, predicted image generator 117 generates, for each small region, predicted image 132 using a weighted average of obtained reference pixels 131. Predicted image 132 is stored into buffer 118, and a plurality of predicted images 132 corresponding to coding block 122 are output as predicted block 133.

Note that frequency transformation processing and quantization processing may be performed one by one as different processing, or may be performed at a time. Similarly, inverse quantization processing and inverse frequency transformation processing may be performed one by one as different processing, or may be performed at a time.

Quantization is processing of digitizing values sampled at predetermined spacings, in association with predetermined levels. Inverse quantization is processing of restoring a value obtained by quantization to a value in an original section. In the data compression field, quantization means processing of dividing a value into sections rougher than the sections of an original value, whereas inverse quantization means processing of redividing the rough sections into the original fine sections. In the codec technical field, quantization and inverse quantization may be referred to as rounding off, rounding, or scaling.

FIG. 4 mainly illustrates a distinguishing configuration of the present embodiment only, yet generally used inter prediction and intra prediction, for instance, may be further used. In this case, a technique which yields highest encoding efficiency is selected for each coding block 122, from among prediction processing, inter prediction, and intra prediction described above.

Here, an example in which N motion vectors are selected for each coding block 122 has been described, yet N motion vectors may be selected for each processing unit into which coding block 122 has been split.

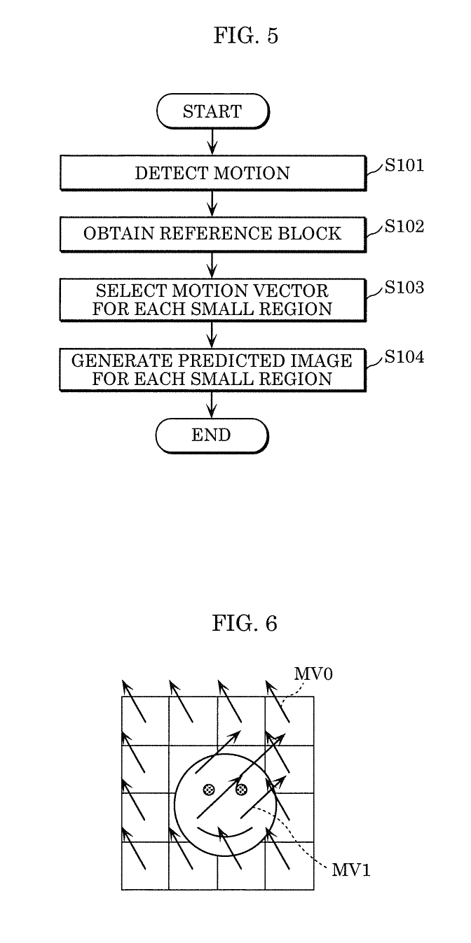

The following describes operation by image encoding device 100. FIG. 5 is a flowchart illustrating an example of operation for inter prediction processing by image encoding device 100.

First, motion detector 111 calculates, by motion detection, N motion vectors in coding block 122 which is a processing target (S101). Specifically, as illustrated in FIG. 6, motion detector 111 obtains a motion vector for each small region, and selects N representative motion vectors from among the obtained motion vectors. For example, motion detector 111 selects N motion vectors which highly frequently occur (which are at a peak of a histogram) from among a plurality of motion vectors. For example, as illustrated in FIG. 6, motion vector MV0 which indicates background motion, and motion vector MV1 which indicates foreground motion (motion of a moving object) are selected.

The image decoding device is notified of information which indicates N selected motion vectors as a portion of encoded bitstream 126. Note that as a searching method, an arbitrary method may be used as long as the method allows motion detection for each small region.

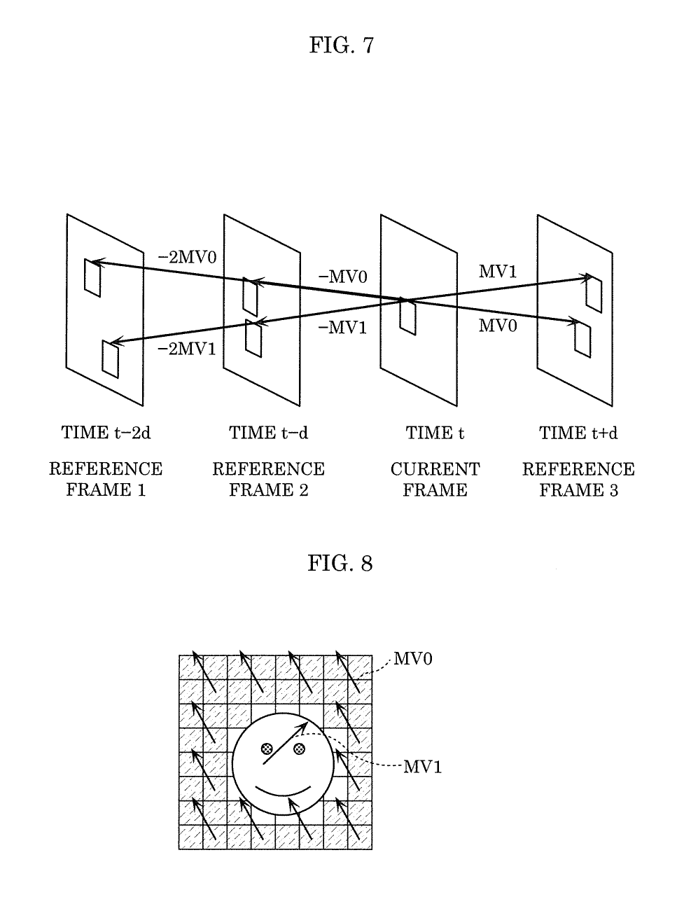

Next, motion compensator 112 obtains a reference block using the motion vectors (S102). Specifically, as illustrated in FIG. 7, motion compensator 112 scales the motion vectors obtained in step S101, and obtains corresponding reference blocks on reference frames.

In the example in FIG. 7, a current frame at time t and reference frames 1 to 3 at time t−2d, time t−d, and time t+d. In this case, motion compensator 112 derives motion vectors −MV0 and −2MV0 by scaling motion vector MV0, and obtains a reference block on reference frame 3 indicated by motion vector MV0, a reference block on reference frame 2 indicated by motion vector MV0, and a reference block on reference frame 1 indicated by motion vector −2MV0. Similarly, motion compensator 112 derives motion vector −MV1 and −2MV1 by scaling motion vector MV1, and obtains a reference block on reference frame 3 indicated by motion vector MV1, a reference block on reference frame 2 indicated by motion vector −MV1, and a reference block on reference frame 1 indicated by motion vector −2MV1. Obtained reference blocks 130 are stored into buffer 114.

Next, controller 116 selects, for each small region, a motion vector from among a plurality of motion vectors (S103). Specifically, controller 116 evaluates, for each small region, a correlation of reference pixels based on motion vectors, assuming that there is linear uniform motion. Then, controller 116 selects, for each small region, a motion vector having a high correlation as illustrated in FIG. 8.

Note that a small region may not only be a rectangular block such as 4×4 pixels or 2×2 pixels, but also be one pixel. When a motion vector is selected per pixel, determination is conceivably unstable since reference pixels on forward and backward frames may accidentally match. In view of this, controller 116 evaluates a correlation for a broad range such as 3×3 pixels or 5 pixels including pixels disposed vertically and horizontally. For example, controller 116 may take a measure such as applying, for instance, a 3×3 pixel low-pass filter to reference pixels or selecting the same vector when vectors selected for surrounding pixels are the same.

Next, predictor 110 generates, for each small region, predicted image 132 (S104). For example, as such a method, it is possible to use a method in which pixels in a reference frame having a time distance close to a current frame to be encoded are used as predicted image 132 (predicted value) or a method in which a weighted average calculated according to a time distance using a plurality of reference pixels is used as predicted image 132, for instance. To calculate a weighted average, a weighting may be explicitly notified for each sequence, each picture, or each slice. There may be a reference frame for which a weighting is set to 0.

In step S103 in FIG. 5, there may be a case where it is difficult to select a motion vector by simple evaluation of a correlation of reference pixels, like when reference pixels in a background region are covered by a foreground. Accordingly, controller 116 further obtains, using a motion vector of the foreground, a point on a current frame to be encoded corresponding to reference pixels, and determines whether a motion vector selected for pixels at the corresponding point is a motion vector of the foreground. For example, a rule is predetermined such as first notifying a motion vector of the background when the image encoding device notifies the image decoding device of motion vectors. Accordingly, the image decoding device can be informed which motion vector is a motion vector of the background. In addition, the image encoding device can determine, for a region for which it is difficult to select a motion vector, a region according to which of motion vectors is a background, by evaluating a correlation of reference pixels with current pixels.

Specifically, if pixels at a corresponding point are indicated by a motion vector of the foreground, controller 116 determines that reference pixels belong to a region according to a motion vector of the foreground, and does not use the reference pixels to predict the region considered to be a background region. On the other hand, if a motion vector selected for pixels at a corresponding point is a motion vector of the background, controller 116 determines that reference pixels belong to a region according to a motion vector of the background, and uses the reference pixels to predict the region considered to be a background region. If it is difficult to select a motion vector for pixels at a corresponding point by only making simple evaluation of a correlation of reference pixels, a corresponding point is considered to belong to a background region covered by the foreground in a reference frame. Thus, controller 116 determines that reference pixels belong to a region according to a motion vector of the background, and uses reference pixels to predict the region considered to be the background region.

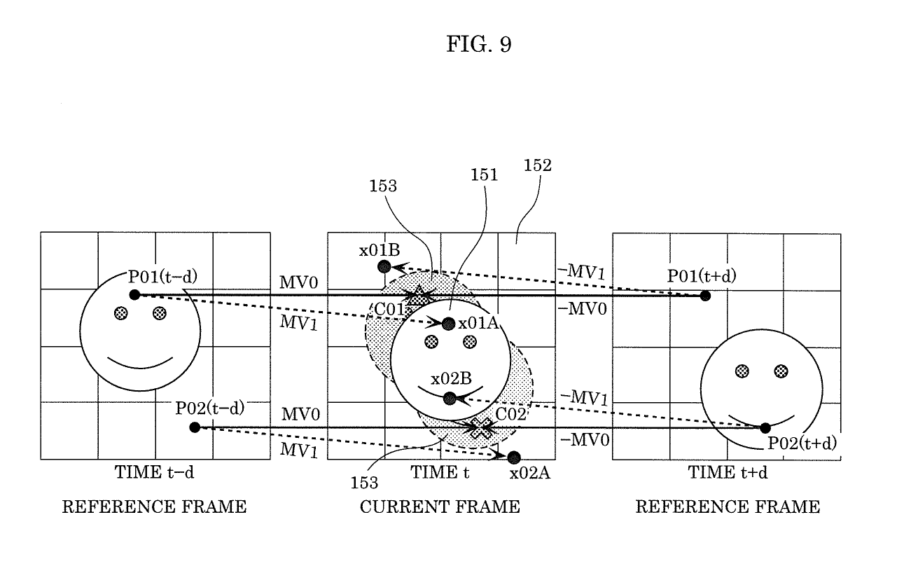

The following describes an example in the case of referring to a total of two reference frames whose display times are before and after the display time of a current frame. FIG. 9 is a diagram illustrating an example of operation in such a case. Here, motion vector MV0 is a motion vector of the background (background vector), and motion vector MV1 is a motion vector of the foreground (foreground vector).

First, through step S103 in FIG. 5, as illustrated in FIG. 9, small regions on a current frame to be encoded are divided into foreground region 151, background region 152, and unidentified region 153. Foreground region 151 is a small region for which a motion vector of the foreground is selected, and background region 152 is a small region for which a motion vector of the background is selected. Unidentified region 153 is a region other than foreground region 151 and background region 152. Unidentified region 153 is considered to be a background region covered by the foreground in a reference frame. Unidentified region 153 is a region for which any motion vectors do not indicate reference pixels having a high correlation. Note that a high/low correlation means that, for example, a correlation is higher/lower than a predetermined reference value.

Next, controller 116 obtains, for unidentified region 153, a corresponding point on a current frame based on foreground vector MV01, for reference pixels based on background vector MV0, and determines which of foreground region 151, background region 152, and unidentified region 153 the corresponding point on the current frame belongs to. Then, controller 116 uses, for prediction, reference pixels whose corresponding point belongs to the background (background region 152 or unidentified region 153). In the example of small region C01 illustrated in FIG. 9, reference pixels P01(t−d) and P01(t+d) based on background vector MV0 are present. Corresponding point X01A of reference pixels P01(t−d) belongs to foreground region 151, and thus reference pixels P01(t−d) are not used for prediction. Corresponding point X01B of reference pixels P01(t+d) belongs to background region 152, and thus reference pixels P01(t+d) are used for prediction. In the example of small region C02, reference pixels P02(t−d) and P02(t+d) based on background vector MV0 are present. Corresponding point X02A of reference pixels P02(t−d) belongs to background region 152, and thus reference pixels P02(t−d) are used for prediction. Corresponding point X02B of reference pixels P02(t+d) belongs to foreground region 151, and thus reference pixels P02(t+d) are not used for prediction.

In the method illustrated in FIG. 9, if all the pixels at a corresponding point are unencoded (undecoded) pixels outside a current block and cannot be used for determination, it is better not to use reference pixels according to the corresponding point to predict a current region. Nevertheless, if the method is a determination method which brings the same result to the image encoding device and the image decoding device, such reference pixels may be used for prediction of the region. Note that even if pixels at a corresponding point are unencoded (undecoded) pixels outside a current block, when other reference pixels for the current region are determined to be in the foreground, the other reference pixels may be determined to be in the background and used for prediction.

In the method in FIG. 9 and the method described above, if pixels to be used for prediction are not found, controller 116 determines that all the pixels on reference frames corresponding to pixels in a current small region are covered by the foreground, and determines a predicted value for the pixels by copying a predicted value (predicted image) for pixels in a background region in the vicinity thereof.

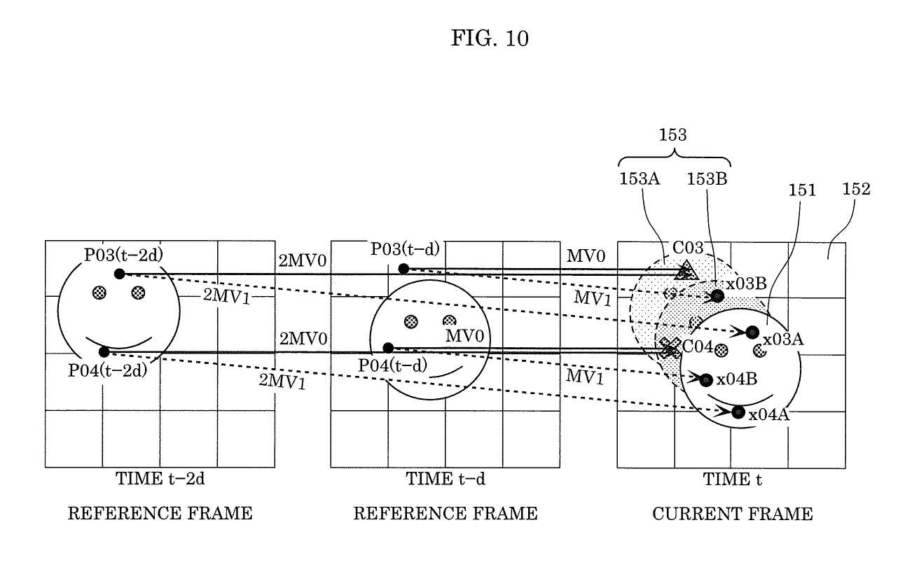

The following describes an example in the case of referring to a total of two reference frames whose display times are before the display time of the current frame only. FIG. 10 is a diagram illustrating an example of operation in this case.

Similarly to the example in FIG. 9, controller 116 divides small regions into foreground region 151, background region 152, and unidentified region 153. Furthermore, controller 116 divides unidentified regions 153 into region 153A for which one reference pixel can be used and region 153B for which no reference pixels that can be used are present.

Specifically, in the example of small region C03 belonging to region 153A, reference pixels P03(t−2d) and P03(t−d) based on background vector MV0 are present. Corresponding point X03A of reference pixels P03(t−2d) belongs to foreground region 151, and thus reference pixels P03(t−2d) are not used for prediction. Corresponding point X03B of reference pixels P03(t−d) belongs to background region 152, and thus reference pixels P03(t−d) are used for prediction.

On the other hand, in the example of small region C04 belonging to region 153B, reference pixels P04(t−2d) and P04(t−d) based on background vector MV0 are present. Reference pixels P04(t−2d) and P04(t−d) both belong to foreground region 151, and thus reference pixels P04(t−2d) and P04(t−d) are not used for prediction. In this case, there are no pixels to be used for reference, and thus controller 116 determines a predicted value for pixels in small region C04 by copying a predicted value for pixels in background region 152 in the vicinity thereof.

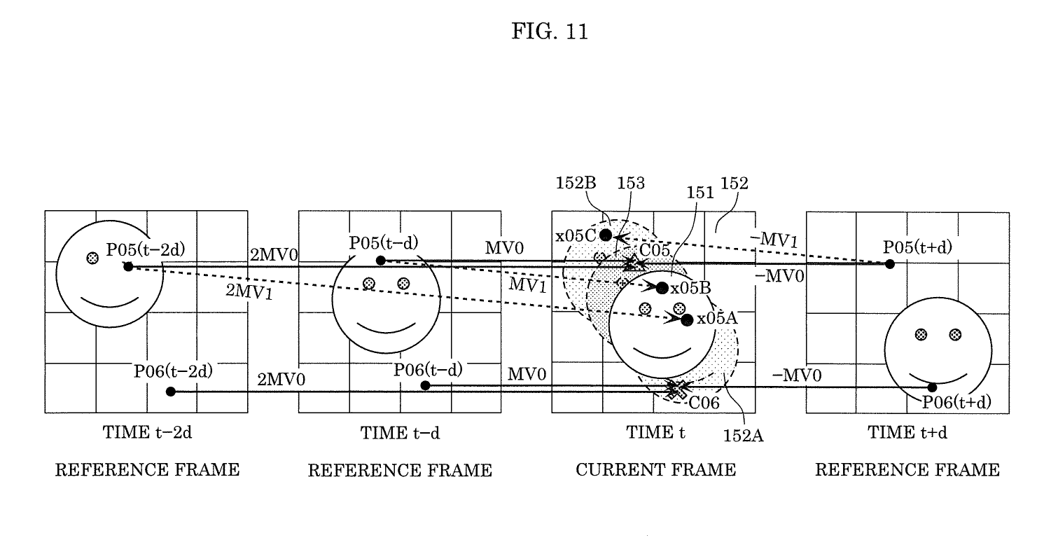

The following describes an example in the case of referring to a total of three reference frames whose display times are before and after the display time of the current frame. FIG. 11 is a diagram illustrating an example of operation in this case.

Similarly to the example in FIGS. 9 and 10, also in this case, controller 116 divides small regions into foreground region 151, background region 152 (152A and 152B), and unidentified region 153.

Specifically, in the example of small region C05 belonging to region 153, reference pixels P05(t−2d), P05(t−d), and P05(t+d) based on background vector MV0 are present. Corresponding points X05A and X05B of reference pixels P05(t−2d) and P05(t−d) belong to foreground region 151, and thus reference pixels P05(t−2d) and P05(t−d) are not used for prediction. Corresponding point X05C of reference pixels P05(t+d) belongs to background region 152, and thus reference pixels P05(t+d) are used for prediction.

Small region C06 belonging to background region 152A is covered by the foreground in the reference frame at time t+d, but has a high correlation with reference pixels P06(t−d) and reference pixels P06(t−2d) on the two reference frames. Accordingly, controller 116 determines small region C06 to be a background region, and uses reference pixels P06(t−d) and P06(t−2d) to determine predicted image 132 of small region C06. Similarly, background region 152B is covered by the foreground in the reference frame at time (t−2d), but has a high correlation with reference pixels on the frames at time (t−d) and time (t+d). Accordingly, controller 116 uses, for background region 152B, the reference pixels on the frames at time (t−d) and time (t+d).

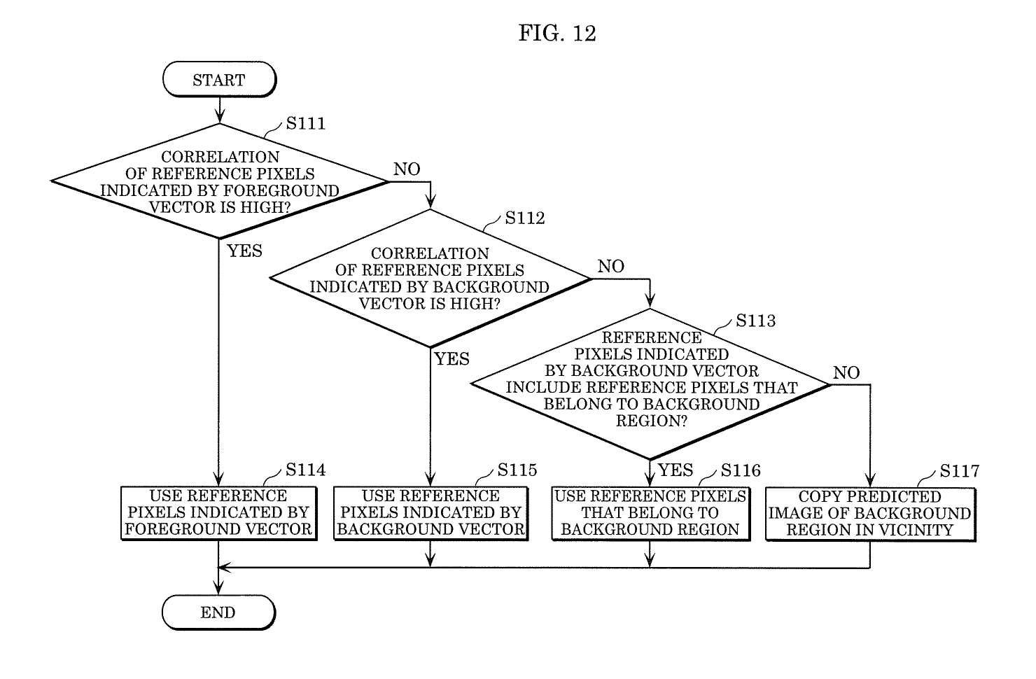

FIG. 12 is a flowchart of processing (steps S103 and S104 in FIG. 5) of selecting a motion vector and reference pixels according to the present embodiment. This processing is performed for each small region.

As illustrated in FIG. 12, if a correlation of a plurality of reference pixels indicated by a foreground vector (a motion vector for the foreground) is high (Yes in S111), controller 116 determines that a small region subjected to processing belongs to a foreground region, selects the foreground vector, and determines to use the plurality of reference pixels indicated by the foreground vector for prediction of the small region subjected to processing (S114).

If a correlation of a plurality of reference pixels indicated by a background vector (a motion vector for the background) is high (Yes in S112), controller 116 determines that a small region subjected to processing belongs to a background region, selects the background vector, and determines to use the plurality of reference pixels indicated by the background vector for prediction of the small region subjected to processing (S115).

Note that as described above, if three or more reference frames are used, controller 116 determines that a small region subjected to processing belongs to a background region, when a correlation of reference pixels on at least two frames is high. Furthermore, controller 116 determines to use, for prediction of a small region subjected to processing, reference pixels having a high correlation among a plurality of reference pixels indicated by a background vector.

If any of reference pixels indicated by a foreground vector and a background vector do not indicate a high correlation (No in S111 and also No in S112), controller 116 determines whether reference pixels which belong to a background region are present among the reference pixels indicated by the background vector (S113). Specifically, as described above, if a corresponding point of reference pixels belongs to a background region, controller 116 determines that the reference pixels belong to the background region.

If reference pixels that belong to the background region are present among the reference pixels indicated by the background vector (Yes in S113), controller 116 determines to use the reference pixels for prediction of a small region subjected to processing (S116).

On the other hand, if the reference pixels indicated by the background vector do not include reference pixels belonging to a background region (No in S113), that is, for example, if all the reference pixels belong to a foreground region or are present outside a block, controller 116 determines to use (copy) a predicted image of a small region included in the background region in the vicinity thereof, for a predicted image of a small region subjected to processing (S117).

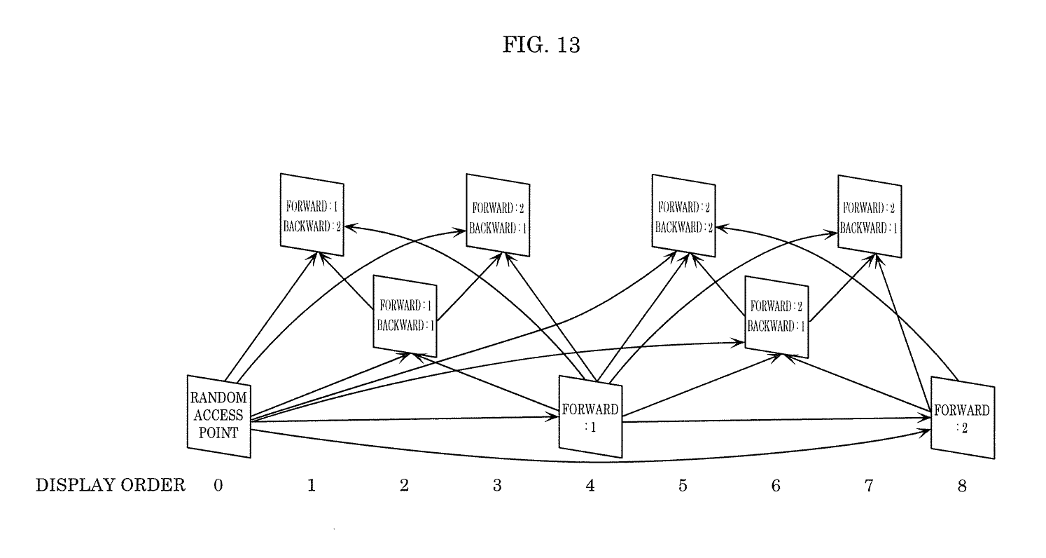

The following describes an example of application of the prediction method according to the present embodiment. FIG. 13 is a diagram illustrating a hierarchical inter prediction encoding structure called HB3. As illustrated in FIG. 13, two or more reference frames can be used for frames other than the zeroth frame (random access point) and the fourth frame in the display order. Accordingly, the prediction method according to the present embodiment is applicable to the frames excluding the zeroth and fourth frames.

Note that the following method can be used as a method of the image encoding device notifying the image decoding device of information indicating that the prediction method according to the present embodiment is used.

For example, as one of prediction types notified for each predicted block, a prediction type which indicates the above prediction method may be added to the conventional prediction type. Alternatively, in conventional bi-prediction in which two motion vectors are notified, only a method of generating a predicted image may be replaced with the prediction method according to the present embodiment. Information for notifying whether to add the prediction method according to the present embodiment as a new prediction type or whether to replace the prediction method of the conventional bi-prediction with the prediction method according to the present embodiment may be embedded in a sequence parameter set (hereinafter, SPS), a picture parameter set (hereinafter, PPS), or a slice header (hereinafter, SH), for instance, and the prediction method may be changed per sequence, picture, or slice.

Note that in the above description, a motion vector and a reference frame to be used are selected for each small region (having 4×4 or 2×2 pixels, for instance) in a coding block, and makes prediction. The size of such a small region may be fixed to a predetermined size such as 4×4 or 2×2 pixels, or information indicating the size may be embedded in SPS, PPS, or SH and the size may be changed per sequence, picture, or slice unit.

The size of a small region is based on a plurality of pixels such as 4×4 pixels, and only when prediction is effective if the size is smaller than 4×4 as in the case where, for instance, the boundary of an object is included in the 4×4 pixels, a hierarchical change can also be made for change in a unit of 2×2 pixels or 1 pixel. By also embedding, in SPS, PPS, or SH, change information that is information indicating whether to make a hierarchical change, control can be changed per sequence, picture, or slice.

In the above description, a motion vector and a reference frame which are to be used are selected for each small region in a coding block, based on a correlation of reference pixels on reference frames, and prediction is made. Yet, by embedding in, for instance SPS, PPS, or SH, a parameter such as a threshold used as a criterion for determining how high a correlation is, adjustment can be made according to the amount of noise in an image when encoding the image.

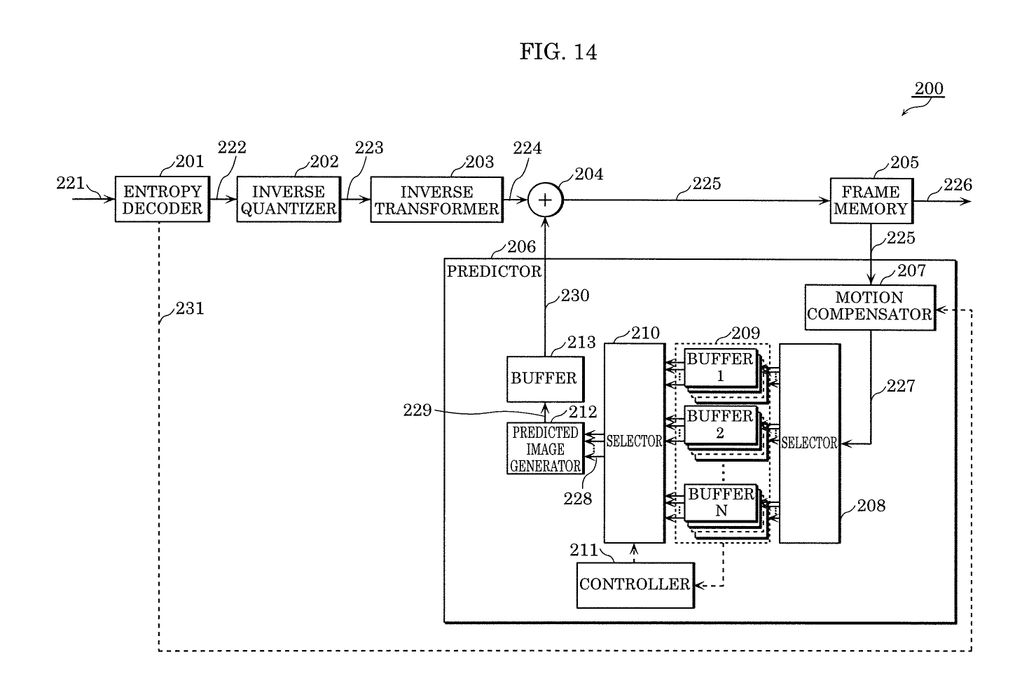

The following describes a configuration of the image decoding device according to the present embodiment. FIG. 14 is a block diagram illustrating an example of a configuration of image decoding device 200 according to the present embodiment. Image decoding device 200 illustrated in FIG. 14 generates decoded image 226 by decoding bitstream 221 which is bitstream 126 generated by image encoding device 100 described above.

Image decoding device 200 includes entropy decoder 201, inverse quantizer 202, inverse transformer 203, adder 204, frame memory 205, and predictor 206.

Entropy decoder 201 decodes coefficient block 222 and motion information 231, from bitstream 221 generated by encoding a still image or video each including one or more pictures. Here, motion information 231 corresponds to motion information 134 described above, and is for identifying a plurality of motion vectors for each coding block.

Inverse quantizer 202 generates coefficient block 223 by performing inverse quantization on coefficient block 222. Inverse transformer 203 generates difference block 224 by performing inverse transformation on coefficient block 223.

Adder 204 generates decoded block 225 by adding difference block 224 and predicted block 230. Decoded block 225 is stored into frame memory 109 and output as decoded image 226, and also is used for prediction processing.

Note that the sizes of difference block 224, decoded block 225, and predicted block 230 are, for example, the same as the size of the above-described coding block which is a prediction processing unit.

Predictor 206 generates predicted block 230 using decoded block 225. Predictor 206 includes motion compensator 207, selectors 208 and 210, buffers 209 and 213, controller 211, and predicted image generator 212.

Note that operation of the processing sections included in predictor 206 is similar to the operation of the processing sections included in predictor 110 included in image encoding device 100 described above. Note that in predictor 110, motion detector 111 detects a plurality of motion vectors for each coding block, yet in predictor 206, motion information 231 included in bitstream 221 indicates a plurality of motion vectors for each coding block.

Specifically, motion compensator 207 generates a plurality of reference blocks 227 by performing motion compensation using N motion vectors indicated by motion information 231. A plurality of (N×M) buffers 209 are divided into N buffer groups. N buffer groups are in one-to-one correspondence with N motion vectors. Each buffer group includes M buffers, and M buffers are in one-to-one correspondence with M reference frames. N x M reference blocks 227 generated by motion compensator 207 are temporarily stored in corresponding buffers 209 via selector 208.

Controller 211 evaluates, for each small region in a coding block and for each motion vector, a correlation of M reference pixels 228 on M reference frames, and selects one motion vector and a plurality of reference frames to be used for prediction. Controller 211 outputs a plurality of reference pixels 228 indicated by motion vectors selected for small regions to predicted image generator 212 via selector 210.

Predicted image generator 212 generates, for each small region, predicted image 229 using obtained reference pixels 228. Predicted image 229 is stored into buffer 213, and a plurality of predicted images 229 for a coding block are output as predicted block 230.

Note that inverse quantization processing and inverse frequency transformation processing may be performed one by one as different processing, or may be performed at a time. Furthermore, according to a currently mainstream coding standard such as HEVC, inverse quantization processing and inverse frequency transformation processing are performed at a time. Also on the decoding side, an expression such as scaling may be used for such processing, similarly to the encoding side.

In addition, similarly to the encoding side, generally used inter prediction and intra prediction, for instance, may be further used. In this case, information indicating which of prediction processing, inter prediction, and intra prediction described above is to be used is included in bitstream 221, and image decoding device 200 selects a prediction method for each coding block according to the information.

Note that although the above description shows an example in which one foreground vector and one background vector are used for each coding block, a plurality of foreground vectors or a plurality of background vectors may be used, or a plurality of foreground vectors and a plurality of background vectors may be used. For example, two foreground vectors and two background vectors may be used. In this case, a plurality of motion vectors are obtained for each small region on reference frame 1, and two motion vectors which highly frequently occur (foreground vector 1 and background vector 2) are selected from among the motion vectors. Similarly, a plurality of motion vectors are obtained for each small region on reference frame 2, and two motion vectors which highly frequently occur (foreground vector 2 and background vector 2) are selected from among the motion vectors.

In this case, as combinations of a foreground vector and a background vector, there are four conceivable combinations, namely (foreground vector 1 and background vector 1), (foreground vector 1 and background vector 2), (foreground vector 2 and background vector 1), and (foreground vector 2 and background vector 2). Accordingly, image encoding device 100 (or image decoding device 200) calculates cost values of such four combinations, and selects a combination having the lowest cost value, as a pair of a foreground vector and a background vector to be used.

Specifically, a sum of a total of the prediction residual of a foreground region, a total of the prediction residual of a background region, a total of the prediction residual of the other regions is calculated as residual of a coding block. Further, a bit amount of motion vectors is calculated. An additional value or a weighting additional value of the residual of the coding block and the bit amount of motion vectors is calculated as a cost value.

Note that if there is no difference (or a small difference) in bit amount of motion vectors, a cost value may be calculated using only the residual of a coding block.

In the above description, when reference pixels of a reference frame cannot be used, a predicted image in a nearby background region is used for a predicted image of a current small region (S117). Nevertheless, a pixel value of a background region near a current small region included in a current frame may be used as a predicted image of the current small region similarly to intra prediction, or may be copied as a pixel value of the current small region.

As described above, image encoding device 100 according to the present embodiment performs image encoding processing illustrated in FIG. 15. First, motion detector 111 detects, for each of processing units (coding blocks 122) obtained by splitting a current frame, motion vectors to be assigned to the processing unit (S121).

Next, based on the motion vectors and reference frames at different times, controller 116 selects, for each of small regions obtained by splitting a processing unit among the processing units, a motion vector to be used, from among the motion vectors (S122).

For example, the reference frames include a first frame and a second frame, and controller 116 obtains, for each of the motion vectors, a correlation between a region (reference pixels 131) on the first frame and a region (reference pixels 131) on the second frame, and selects a highly correlated motion vector, the regions being indicated by the motion vector from a current small region included in a current frame. Note that a motion vector used here is a motion vector itself or a motion vector obtained by scaling the motion vector according to a time distance between a current frame and a reference frame.

The motion vectors include a background vector indicating background motion, and a foreground vector indicating foreground motion. Controller 116 selects the background vector when a correlation between regions indicated by the background vector and a correlation between regions indicated by the foreground vector are each lower than a predetermined value.

Next, predicted image generator 117 generates, for each of the small regions, predicted image 132 using the selected motion vector (S123). For example, if a correlation between regions indicated by the background vector and a correlation between regions indicated by the foreground vector are each lower than the predetermined value, predicted image generator 117 generates predicted image 132 using a region belonging to the background, among a first region on a first frame and a second region on a second frame which are indicated by the background vector. For example, predicted image generator 117 determines that the first region (or the second region) belongs to the background if a corresponding point which is a region on the current frame and is indicated by a foreground vector from the first region (or the second region) belongs to a background. If neither the first region nor the second region belongs to the background, predicted image generator 117 generates predicted image 132 of a current small region in a current frame, using a predicted image of a region near the current small region.

Next, encoder (subtractor 102, transformer 103, quantizer 104, and entropy encoder 105, for instance) encodes each of a plurality of small regions using predicted image 132 generated for the small region (S124). Specifically, the encoder calculates a difference between a pixel value of a small region and predicted image 132, and generates bitstream 126 by performing frequency transformation, quantization, and entropy encoding (variable length encoding) on the difference.

Note that information detected in step S121 and indicating a plurality of motion vectors for each processing unit is included in bitstream 126 by being encoded. On the other hand, information indicating one motion vector selected for each small region in step S122 is not included in bitstream 126. Stated differently, information indicating one motion vector for each small region is not sent to the image decoding device.

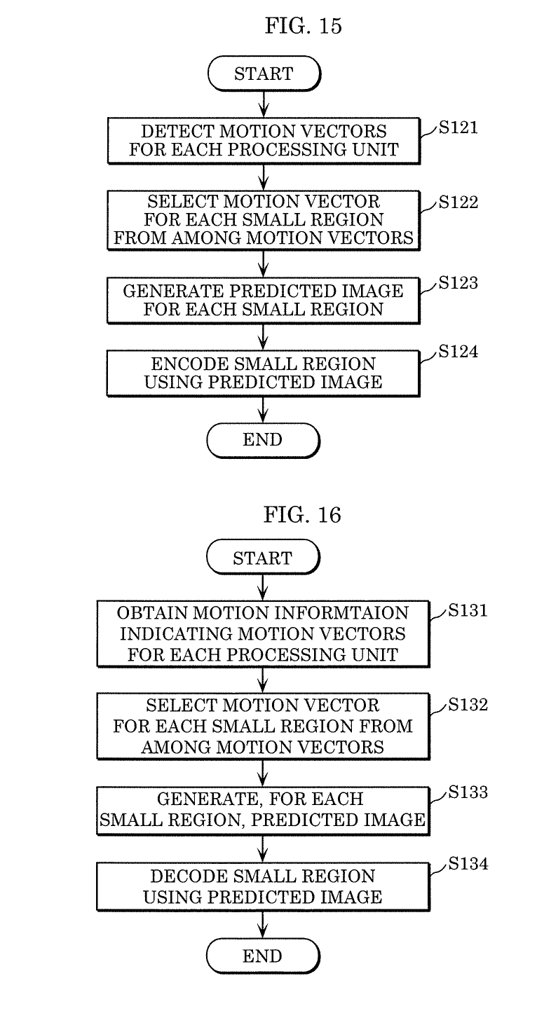

Image decoding device 200 according to the present embodiment performs image decoding processing illustrated in FIG. 16. First, entropy decoder 201 obtains, for each of processing units (coding blocks) obtained by splitting a current frame, motion vectors assigned to the processing unit (S131). Specifically, entropy decoder 201 obtains, from bitstream 221, motion information 231 which indicates a plurality of motion vectors assigned to a processing unit.

Next, based on the motion vectors and reference frames at different times, controller 211 selects, for each of small regions obtained by splitting a processing unit, a motion vector to be used from among the motion vectors (S132).

For example, the reference frames include a first frame and a second frame, and controller 211 obtains, for each of the motion vectors, a correlation between a region (reference pixels 228) on the first frame and a region (reference pixels 228) on a second frame, and selects a highly correlated motion vector, the regions being indicated by the motion vector from a current small region included in a current frame.

The motion vectors include a background vector which indicates background motion and a foreground vector which indicates foreground motion. Controller 211 selects a background vector if a correlation between regions indicated by the background vector and a correlation between regions indicated by the foreground vector are each lower than a predetermined value.

Next, predicted image generator 212 generates, for each of small regions, predicted image 229 using a selected motion vector (S133). For example, if a correlation between the regions indicated by the background vector and a correlation between the regions indicated by the foreground vector are each lower than the predetermined value, predicted image generator 212 generates a predicted image using a region belonging to the background among the first region on the first frame and the second region on the second frame which are indicated by the background vector. For example, if a corresponding point which is a region on the current frame and is indicated by the foreground vector from the first region (or the second region) belongs to the background, predicted image generator 212 determines that the first region (or the second region) belongs to the background. If neither the first region nor the second region belongs to the background, predicted image generator 212 generates predicted image 229 of a current small region in a current frame using a predicted image of a region near the current small region.

Next, a decoder (entropy decoder 201, inverse quantizer 202, inverse transformer 203, and adder 204, for instance) decodes each of a plurality of small regions using predicted image 229 generated for the small region (S134). Specifically, the decoder restores the difference value of a small region by performing entropy decoding (variable-length decoding), inverse quantization, and inverse frequency transformation on encoded data of the small region. The decoder restores a pixel value of the small region by adding predicted image 229 to the difference value.

Note that the information which indicates a motion vector for each small region is not included in bitstream 221. Specifically, information which indicates a motion vector for each small region is not sent to the image decoding device.

From the above, a motion vector to be used for a small region can be selected from among a plurality of motion vectors associated with each processing unit in the image decoding device. Accordingly, it is possible to use different motion vectors for a plurality of small regions included in a processing unit. It is not necessary to include, in an encoded bitstream, information for designating a motion vector for each small region, and thus an increase in the data volume of the encoded bitstream can be inhibited. Thus, image encoding device 100 and image decoding device 200 according to the present embodiment can improve encoding efficiency.

The above has described the image encoding device and the image decoding device according to the present embodiment, yet the present disclosure is not limited to this embodiment.

The processing sections included in the image encoding device and the image decoding device according to the above embodiment are typically achieved as large scale integrated circuits (LSI). These may be each formed as a single chip or may be formed as a single chip that includes some or all of the blocks.

Furthermore, ways to achieve integration are not limited to LSIs, and implementation through a dedicated circuit or a general-purpose processor is also possible. A field programmable gate array (FPGA) that can be programmed after manufacturing an LSI or a reconfigurable processor that allows re-configuration of the connection or configuration of circuit cells inside an LSI can be used for the same purpose.

In the above embodiments, each of the elements may be constituted by dedicated hardware, or may be obtained by executing a software program suitable for the element. Each element may be obtained by a program executor such as a CPU or a processor reading and executing a software program recorded on a recording medium such as a hard disk or semiconductor memory.

In other words, the image encoding device and the image decoding device include processing circuitry, and storage electrically connected to the processing circuitry (accessible from the processing circuitry). The processing circuitry includes at least one of dedicated hardware and a program executor. When the processing circuitry includes a program executor, the storage stores a software program executed by the program executor. The processing circuitry performs an image encoding method or an image decoding method according to the above embodiments using the storage.

Furthermore, the present disclosure may be the above software program, or a non-transitory computer-readable recording medium in which the above program is recorded. Also, it is needless to say that such a program can be distributed via a transmission medium such as the Internet.

The numerals used above are all examples in order to specifically describe the present disclosure, and thus the present disclosure is not limited to the exemplified numerals.

Split of functional blocks in a block diagram is an example, and thus a plurality of functional blocks may be achieved as one functional block, one functional block may be split into a plurality of blocks, or some functions may be transferred to another functional block. Single hardware or software may process similar functions of a plurality of functional blocks, in parallel or by time division.

The order in which steps included in the image encoding method or the image decoding method are performed is an example for specifically describing the present disclosure, and the order other than the above may be applied. Further, some of the steps may be performed simultaneously (in parallel) with other steps.

The above has described, based on the embodiments, the image encoding device, the image decoding device, the image encoding method, and the image decoding method according to one or more aspects of the present disclosure, yet the present disclosure is not limited to the above embodiments. The scope of the one or more aspects of the present disclosure also encompasses embodiments as a result of adding, to the embodiments, various modifications that may be conceived by those skilled in the art, and embodiments obtained by combining elements in different embodiments as long as the resultant embodiments do not depart from the spirit of the present disclosure.

### Embodiment 2

As described in each of the above embodiments, each functional block can typically be realized as an MPU and memory, for example. Moreover, processes performed by each of the functional blocks are typically realized by a program execution unit, such as a processor, reading and executing software (a program) recorded on a recording medium such as ROM. The software may be distributed via, for example, downloading, and may be recorded on a recording medium such as semiconductor memory and distributed. Note that each functional block can, of course, also be realized as hardware (dedicated circuit).

Moreover, the processing described in each of the embodiments may be realized via integrated processing using a single apparatus (system), and, alternatively, may be realized via decentralized processing using a plurality of apparatuses. Moreover, the processor that executes the above-described program may be a single processor or a plurality of processors. In other words, integrated processing may be performed, and, alternatively, decentralized processing may be performed.

The present disclosure is not limited to the above exemplary embodiments; various modifications may be made to the exemplary embodiments, the results of which are also included within the scope of the embodiments of the present disclosure.

Next, application examples of the moving picture encoding method (image encoding method) and the moving picture decoding method (image decoding method) described in each of the above embodiments and a system that employs the same will be described. The system is characterized as including an image encoding device that employs the image encoding method, an image decoding device that employs the image decoding method, and an image encoding/decoding device that includes both the image encoding device and the image decoding device. Other configurations included in the system may be modified on a case-by-case basis.

### (Usage Examples)

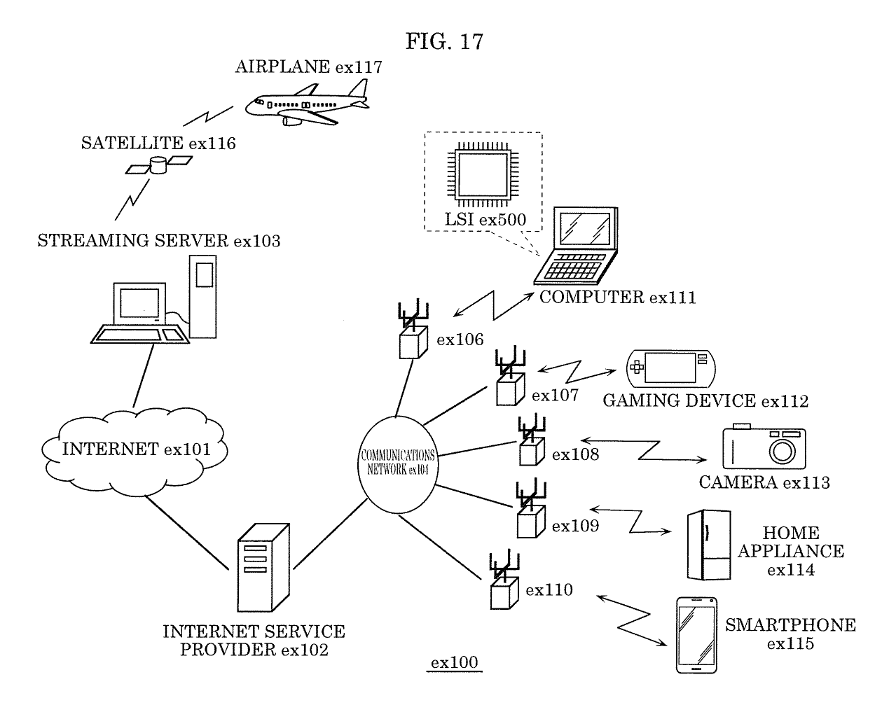

FIG. 17 illustrates an overall configuration of content providing system ex100 for implementing a content distribution service. The area in which the communication service is provided is divided into cells of desired sizes, and base stations ex105, ex106, ex107, ex108, ex109, ex110, and ex110, which are fixed wireless stations, are located in respective cells.

In content providing system ex100, devices including computer ex111, gaming device ex112, camera ex113, home appliance ex114, and smartphone ex115 are connected to internet ex101 via internet service provider ex102 or communications network ex104 and base stations ex105 through ex111. Content providing system ex100 may combine and connect any combination of the above elements. The devices may be directly or indirectly connected together via a telephone network or near field communication rather than via base stations ex105 through ex111, which are fixed wireless stations. Moreover, streaming server ex103 is connected to devices including computer ex111, gaming device ex112, camera ex113, home appliance ex114, and smartphone ex115 via, for example, internet ex201. Streaming server ex103 is also connected to, for example, a terminal in a hotspot in airplane ex117 via satellite ex116.

Note that instead of base stations ex105 through ex111, wireless access points or hotspots may be used. Streaming server ex103 may be connected to communications network ex104 directly instead of via internet ex101 or internet service provider ex102, and may be connected to airplane ex117 directly instead of via satellite ex116.

Camera ex113 is a device capable of capturing still images and video, such as a digital camera. Smartphone ex115 is a smartphone device, cellular phone, or personal handyphone system (PHS) phone that can operate under the mobile communications system standards of the typical 2G, 3G, 3.9G, and 4G systems, as well as the next-generation 5G system.

Home appliance ex118 is, for example, a refrigerator or a device included in a home fuel cell cogeneration system.

In content providing system ex100, a terminal including an image and/or video capturing function is capable of, for example, live streaming by connecting to streaming server ex103 via, for example, base station ex105. When live streaming, a terminal (e.g., computer ex111, gaming device ex112, camera ex113, home appliance ex114, smartphone ex115, or airplane ex117) performs the encoding processing described in the above embodiments on still-image or video content captured by a user via the terminal, multiplexes video data obtained via the encoding and audio data obtained by encoding audio corresponding to the video, and transmits the obtained data to streaming server ex103. In other words, the terminal functions as the image encoding device according to one aspect of the present disclosure.

Streaming server ex103 streams transmitted content data to clients that request the stream. Client examples include computer ex111, gaming device 112, camera ex113, home appliance ex114, smartphone ex115, and terminals inside airplane ex117, which are capable of decoding the above-described encoded data. Devices that receive the streamed data decode and reproduce the received data. In other words, the devices each function as the image decoding device according to one aspect of the present disclosure.

### (Decentralized Processing)

Streaming server ex103 may be realized as a plurality of servers or computers between which tasks such as the processing, recording, and streaming of data are divided. For example, streaming server ex103 may be realized as a content delivery network (CDN) that streams content via a network connecting multiple edge servers located throughout the world. In a CDN, an edge server physically near the client is dynamically assigned to the client. Content is cached and streamed to the edge server to reduce load times. In the event of, for example, some kind of an error or a change in connectivity due to, for example, a spike in traffic, it is possible to stream data stably at high speeds since it is possible to avoid affected parts of the network by, for example, dividing the processing between a plurality of edge servers or switching the streaming duties to a different edge server, and continuing streaming.

Decentralization is not limited to just the division of processing for streaming; the encoding of the captured data may be divided between and performed by the terminals, on the server side, or both. In one example, in typical encoding, the processing is performed in two loops. The first loop is for detecting how complicated the image is on a frame-by-frame or scene-by-scene basis, or detecting the encoding load. The second loop is for processing that maintains image quality and improves encoding efficiency. For example, it is possible to reduce the processing load of the terminals and improve the quality and encoding efficiency of the content by having the terminals perform the first loop of the encoding and having the server side that received the content perform the second loop of the encoding. In such a case, upon receipt of a decoding request, it is possible for the encoded data resulting from the first loop performed by one terminal to be received and reproduced on another terminal in approximately real time. This makes it possible to realize smooth, real-time streaming.

In another example, camera ex113 or the like extracts a feature amount from an image, compresses data related to the feature amount as metadata, and transmits the compressed metadata to a server. For example, the server determines the significance of an object based on the feature amount and changes the quantization accuracy accordingly to perform compression suitable for the meaning of the image. Feature amount data is particularly effective in improving the precision and efficiency of motion vector prediction during the second compression pass performed by the server. Moreover, encoding that has a relatively low processing load, such as variable length coding (VLC), may be handled by the terminal, and encoding that has a relatively high processing load, such as context-adaptive binary arithmetic coding (CABAC), may be handled by the server.

In yet another example, there are instances in which a plurality of videos of approximately the same scene are captured by a plurality of terminals in, for example, a stadium, shopping mall, or factory. In such a case, for example, the encoding may be decentralized by dividing processing tasks between the plurality of terminals that captured the videos and, if necessary, other terminals that did not capture the videos and the server, on a per-unit basis. The units may be, for example, groups of pictures (GOP), pictures, or tiles resulting from dividing a picture. This makes it possible to reduce load times and achieve streaming that is closer to real-time.

Moreover, since the videos are of approximately the same scene, management and/or instruction may be carried out by the server so that the videos captured by the terminals can be cross-referenced. Moreover, the server may receive encoded data from the terminals, change reference relationship between items of data or correct or replace pictures themselves, and then perform the encoding. This makes it possible to generate a stream with increased quality and efficiency for the individual items of data.

Moreover, the server may stream video data after performing transcoding to convert the encoding format of the video data. For example, the server may convert the encoding format from MPEG to VP, and may convert H.264 to H.265.

In this way, encoding can be performed by a terminal or one or more servers. Accordingly, although the device that performs the encoding is referred to as a “server” or “terminal” in the following description, some or all of the processes performed by the server may be performed by the terminal, and likewise some or all of the processes performed by the terminal may be performed by the server. This also applies to decoding processes.

### (3D, Multi-Angle)

In recent years, usage of images or videos combined from images or videos of different scenes concurrently captured or the same scene captured from different angles by a plurality of terminals such as camera ex113 and/or smartphone ex115 has increased. Videos captured by the terminals are combined based on, for example, the separately-obtained relative positional relationship between the terminals, or regions in a video having matching feature points.

In addition to the encoding of two-dimensional moving pictures, the server may encode a still image based on scene analysis of a moving picture either automatically or at a point in time specified by the user, and transmit the encoded still image to a reception terminal. Furthermore, when the server can obtain the relative positional relationship between the video capturing terminals, in addition to two-dimensional moving pictures, the server can generate three-dimensional geometry of a scene based on video of the same scene captured from different angles. Note that the server may separately encode three-dimensional data generated from, for example, a point cloud, and may, based on a result of recognizing or tracking a person or object using three-dimensional data, select or reconstruct and generate a video to be transmitted to a reception terminal from videos captured by a plurality of terminals.

This allows the user to enjoy a scene by freely selecting videos corresponding to the video capturing terminals, and allows the user to enjoy the content obtained by extracting, from three-dimensional data reconstructed from a plurality of images or videos, a video from a selected viewpoint. Furthermore, similar to with video, sound may be recorded from relatively different angles, and the server may multiplex, with the video, audio from a specific angle or space in accordance with the video, and transmit the result.

In recent years, content that is a composite of the real world and a virtual world, such as virtual reality (VR) and augmented reality (AR) content, has also become popular. In the case of VR images, the server may create images from the viewpoints of both the left and right eyes and perform encoding that tolerates reference between the two viewpoint images, such as multi-view coding (MVC), and, alternatively, may encode the images as separate streams without referencing. When the images are decoded as separate streams, the streams may be synchronized when reproduced so as to recreate a virtual three-dimensional space in accordance with the viewpoint of the user.

In the case of AR images, the server superimposes virtual object information existing in a virtual space onto camera information representing a real-world space, based on a three-dimensional position or movement from the perspective of the user. The decoding device may obtain or store virtual object information and three-dimensional data, generate two-dimensional images based on movement from the perspective of the user, and then generate superimposed data by seamlessly connecting the images. Alternatively, the decoding device may transmit, to the server, motion from the perspective of the user in addition to a request for virtual object information, and the server may generate superimposed data based on three-dimensional data stored in the server in accordance with the received motion, and encode and stream the generated superimposed data to the decoding device. Note that superimposed data includes, in addition to RGB values, an α value indicating transparency, and the server sets the α value for sections other than the object generated from three-dimensional data to, for example, 0, and may perform the encoding while those sections are transparent. Alternatively, the server may set the background to a predetermined RGB value, such as a chroma key, and generate data in which areas other than the object are set as the background.

Decoding of similarly streamed data may be performed by the client (i.e., the terminals), on the server side, or divided therebetween. In one example, one terminal may transmit a reception request to a server, the requested content may be received and decoded by another terminal, and a decoded signal may be transmitted to a device having a display. It is possible to reproduce high image quality data by decentralizing processing and appropriately selecting content regardless of the processing ability of the communications terminal itself. In yet another example, while a TV, for example, is receiving image data that is large in size, a region of a picture, such as a tile obtained by dividing the picture, may be decoded and displayed on a personal terminal or terminals of a viewer or viewers of the TV. This makes it possible for the viewers to share a big-picture view as well as for each viewer to check his or her assigned area or inspect a region in further detail up close.

In the future, both indoors and outdoors, in situations in which a plurality of wireless connections are possible over near, mid, and far distances, it is expected to be able to seamlessly receive content even when switching to data appropriate for the current connection, using a streaming system standard such as MPEG-DASH. With this, the user can switch between data in real time while freely selecting a decoding device or display apparatus including not only his or her own terminal, but also, for example, displays disposed indoors or outdoors. Moreover, based on, for example, information on the position of the user, decoding can be performed while switching which terminal handles decoding and which terminal handles the displaying of content. This makes it possible to, while in route to a destination, display, on the wall of a nearby building in which a device capable of displaying content is embedded or on part of the ground, map information while on the move. Moreover, it is also possible to switch the bit rate of the received data based on the accessibility to the encoded data on a network, such as when encoded data is cached on a server quickly accessible from the reception terminal or when encoded data is copied to an edge server in a content delivery service.

### (Scalable Encoding)

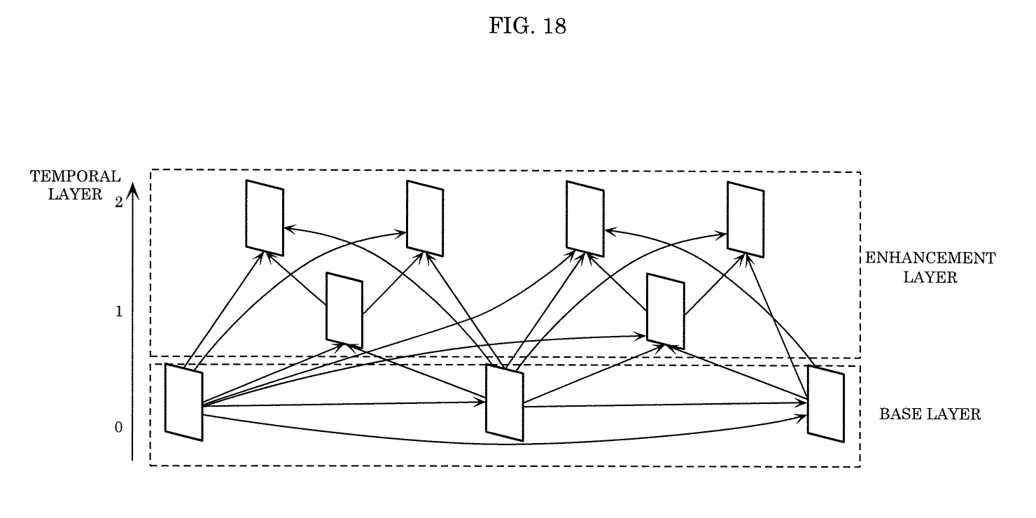

The switching of content will be described with reference to a scalable stream, illustrated in FIG. 18, that is compression coded via implementation of the moving picture encoding method described in the above embodiments. The server may have a configuration in which content is switched while making use of the temporal and/or spatial scalability of a stream, which is achieved by division into and encoding of layers, as illustrated in FIG. 18. Note that there may be a plurality of individual streams that are of the same content but different quality. In other words, by determining which layer to decode up to based on internal factors, such as the processing ability on the decoding device side, and external factors, such as communication bandwidth, the decoding device side can freely switch between low resolution content and high resolution content while decoding. For example, in a case in which the user wants to continue watching, at home on a device such as a TV connected to the internet, a video that he or she had been previously watching on smartphone ex115 while on the move, the device can simply decode the same stream up to a different layer, which reduces server side load.

Furthermore, in addition to the configuration described above in which scalability is achieved as a result of the pictures being encoded per layer and the enhancement layer is above the base layer, the enhancement layer may include metadata based on, for example, statistical information on the image, and the decoding device side may generate high image quality content by performing super-resolution imaging on a picture in the base layer based on the metadata. Super-resolution imaging may be improving the SN ratio while maintaining resolution and/or increasing resolution. Metadata includes information for identifying a linear or a non-linear filter coefficient used in super-resolution processing, or information identifying a parameter value in filter processing, machine learning, or least squares method used in super-resolution processing.

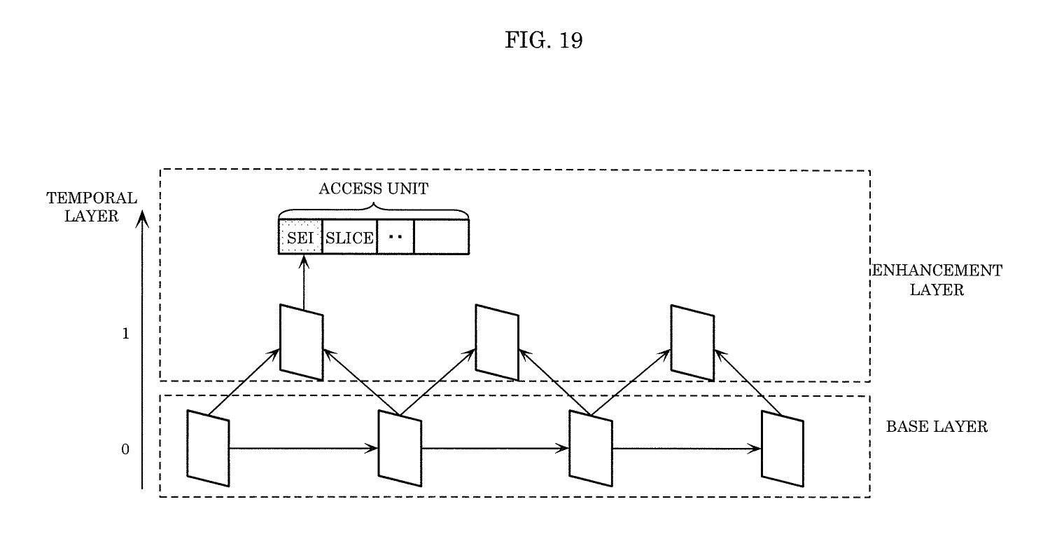

Alternatively, a configuration in which a picture is divided into, for example, tiles in accordance with the meaning of, for example, an object in the image, and on the decoding device side, only a partial region is decoded by selecting a tile to decode, is also acceptable. Moreover, by storing an attribute about the object (person, car, ball, etc.) and a position of the object in the video (coordinates in identical images) as metadata, the decoding device side can identify the position of a desired object based on the metadata and determine which tile or tiles include that object. For example, as illustrated in FIG. 19, metadata is stored using a data storage structure different from pixel data such as an SEI message in HEVC. This metadata indicates, for example, the position, size, or color of the main object.

Moreover, metadata may be stored in units of a plurality of pictures, such as stream, sequence, or random access units. With this, the decoding device side can obtain, for example, the time at which a specific person appears in the video, and by fitting that with picture unit information, can identify a picture in which the object is present and the position of the object in the picture.

### (Web Page Optimization)

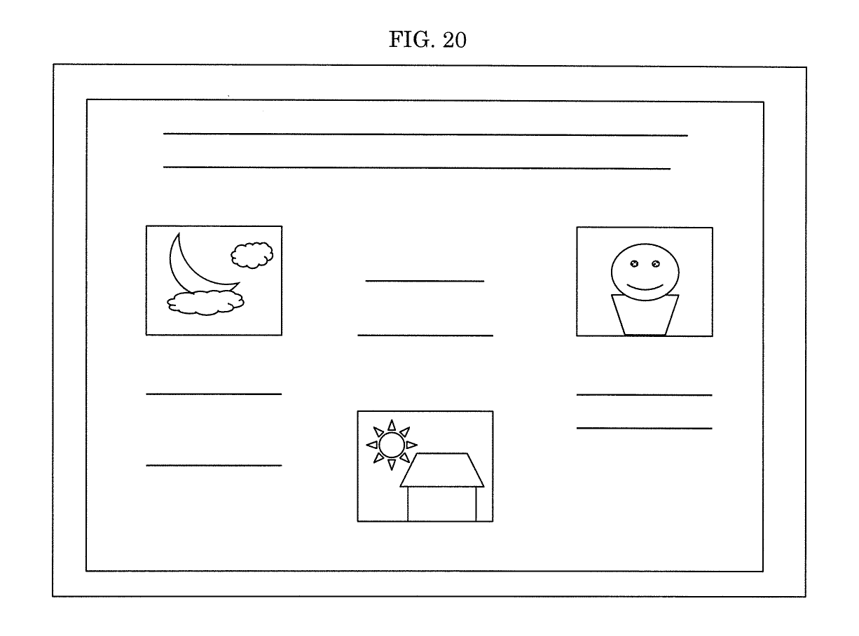

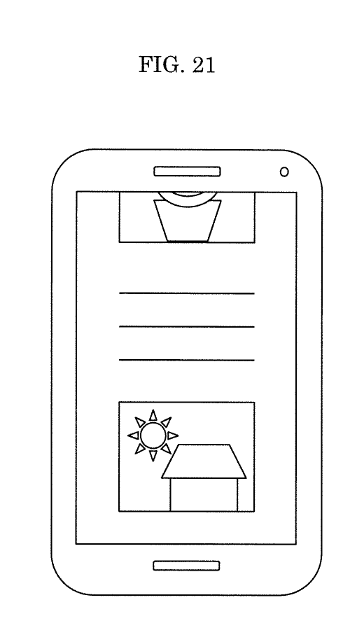

FIG. 20 illustrates an example of a display screen of a web page on, for example, computer ex111. FIG. 21 illustrates an example of a display screen of a web page on, for example, smartphone ex115. As illustrated in FIG. 20 and FIG. 21, a web page may include a plurality of image links which are links to image content, and the appearance of the web page differs depending on the device used to view the web page. When a plurality of image links are viewable on the screen, until the user explicitly selects an image link, or until the image link is in the approximate center of the screen or the entire image link fits in the screen, the display apparatus (decoding device) displays, as the image links, still images included in the content or I pictures, displays video such as an animated gif using a plurality of still images or I pictures, for example, or receives only the base layer and decodes and displays the video.

When an image link is selected by the user, the display apparatus decodes giving the highest priority to the base layer. Note that if there is information in the HTML code of the web page indicating that the content is scalable, the display apparatus may decode up to the enhancement layer. Moreover, in order to guarantee real time reproduction, before a selection is made or when the bandwidth is severely limited, the display apparatus can reduce delay between the point in time at which the leading picture is decoded and the point in time at which the decoded picture is displayed (that is, the delay between the start of the decoding of the content to the displaying of the content) by decoding and displaying only forward reference pictures (I picture, P picture, forward reference B picture). Moreover, the display apparatus may purposely ignore the reference relationship between pictures and coarsely decode all B and P pictures as forward reference pictures, and then perform normal decoding as the number of pictures received over time increases.

### (Autonomous Driving)

When transmitting and receiving still image or video data such two- or three-dimensional map information for autonomous driving or assisted driving of an automobile, the reception terminal may receive, in addition to image data belonging to one or more layers, information on, for example, the weather or road construction as metadata, and associate the metadata with the image data upon decoding. Note that metadata may be assigned per layer and, alternatively, may simply be multiplexed with the image data.

In such a case, since the automobile, drone, airplane, etc., including the reception terminal is mobile, the reception terminal can seamlessly receive and decode while switching between base stations among base stations ex106 through ex110 by transmitting information indicating the position of the reception terminal upon reception request. Moreover, in accordance with the selection made by the user, the situation of the user, or the bandwidth of the connection, the reception terminal can dynamically select to what extent the metadata is received or to what extent the map information, for example, is updated.

With this, in content providing system ex100, the client can receive, decode, and reproduce, in real time, encoded information transmitted by the user.

### (Streaming of Individual Content)

In content providing system ex100, in addition to high image quality, long content distributed by a video distribution entity, unicast or multicast streaming of low image quality, short content from an individual is also possible. Moreover, such content from individuals is likely to further increase in popularity. The server may first perform editing processing on the content before the encoding processing in order to refine the individual content. This may be achieved with, for example, the following configuration.

In real-time while capturing video or image content or after the content has been captured and accumulated, the server performs recognition processing based on the raw or encoded data, such as capture error processing, scene search processing, meaning analysis, and/or object detection processing. Then, based on the result of the recognition processing, the server—either when prompted or automatically—edits the content, examples of which include: correction such as focus and/or motion blur correction; removing low-priority scenes such as scenes that are low in brightness compared to other pictures or out of focus; object edge adjustment; and color tone adjustment. The server encodes the edited data based on the result of the editing. It is known that excessively long videos tend to receive fewer views. Accordingly, in order to keep the content within a specific length that scales with the length of the original video, the server may, in addition to the low-priority scenes described above, automatically clip out scenes with low movement based on an image processing result. Alternatively, the server may generate and encode a video digest based on a result of an analysis of the meaning of a scene.

Note that there are instances in which individual content may include content that infringes a copyright, moral right, portrait rights, etc. Such an instance may lead to an unfavorable situation for the creator, such as when content is shared beyond the scope intended by the creator. Accordingly, before encoding, the server may, for example, edit images so as to blur faces of people in the periphery of the screen or blur the inside of a house, for example. Moreover, the server may be configured to recognize the faces of people other than a registered person in images to be encoded, and when such faces appear in an image, for example, apply a mosaic filter to the face of the person. Alternatively, as pre- or post-processing for encoding, the user may specify, for copyright reasons, a region of an image including a person or a region of the background be processed, and the server may process the specified region by, for example, replacing the region with a different image or blurring the region. If the region includes a person, the person may be tracked in the moving picture the head region may be replaced with another image as the person moves.

Moreover, since there is a demand for real-time viewing of content produced by individuals, which tends to be small in data size, the decoding device first receives the base layer as the highest priority and performs decoding and reproduction, although this may differ depending on bandwidth. When the content is reproduced two or more times, such as when the decoding device receives the enhancement layer during decoding and reproduction of the base layer and loops the reproduction, the decoding device may reproduce a high image quality video including the enhancement layer. If the stream is encoded using such scalable encoding, the video may be low quality when in an unselected state or at the start of the video, but it can offer an experience in which the image quality of the stream progressively increases in an intelligent manner. This is not limited to just scalable encoding; the same experience can be offered by configuring a single stream from a low quality stream reproduced for the first time and a second stream encoded using the first stream as a reference.

### (Other Usage Examples)

The encoding and decoding may be performed by LSI ex500, which is typically included in each terminal. LSI ex500 may be configured of a single chip or a plurality of chips. Software for encoding and decoding moving pictures may be integrated into some type of a recording medium (such as a CD-ROM, a flexible disk, or a hard disk) that is readable by, for example, computer ex111, and the encoding and decoding may be performed using the software. Furthermore, when smartphone ex115 is equipped with a camera, the video data obtained by the camera may be transmitted. In this case, the video data is coded by LSI ex500 included in smartphone ex115.

Note that LSI ex500 may be configured to download and activate an application. In such a case, the terminal first determines whether it is compatible with the scheme used to encode the content or whether it is capable of executing a specific service. When the terminal is not compatible with the encoding scheme of the content or when the terminal is not capable of executing a specific service, the terminal first downloads a codec or application software then obtains and reproduces the content.

Aside from the example of content providing system ex100 that uses internet ex101, at least the moving picture encoding device (image encoding device) or the moving picture decoding device (image decoding device) described in the above embodiments may be implemented in a digital broadcasting system. The same encoding processing and decoding processing may be applied to transmit and receive broadcast radio waves superimposed with multiplexed audio and video data using, for example, a satellite, even though this is geared toward multicast whereas unicast is easier with content providing system ex100.

### (Hardware Configuration)

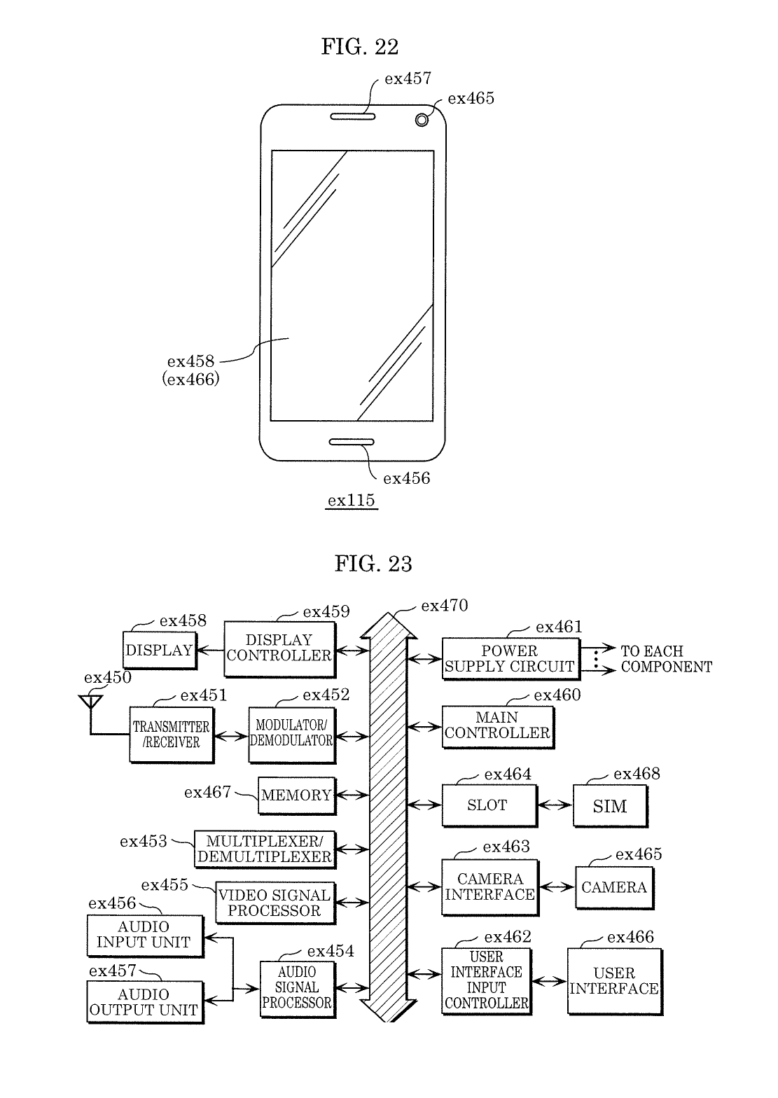

FIG. 22 illustrates smartphone ex115. FIG. 23 illustrates a configuration example of smartphone ex115. Smartphone ex115 includes antenna ex450 for transmitting and receiving radio waves to and from base station ex110, camera ex465 capable of capturing video and still images, and display ex458 that displays decoded data, such as video captured by camera ex465 and video received by antenna ex450. Smartphone ex115 further includes user interface ex466 such as a touch panel, audio output unit ex457 such as a speaker for outputting speech or other audio, audio input unit ex456 such as a microphone for audio input, memory ex467 capable of storing decoded data such as captured video or still images, recorded audio, received video or still images, and mail, as well as decoded data, and slot ex464 which is an interface for SIM ex468 for authorizing access to a network and various data. Note that external memory may be used instead of memory ex467.

Moreover, main controller ex460 which comprehensively controls display ex458 and user interface ex466, power supply circuit ex461, user interface input controller ex462, video signal processor ex455, camera interface ex463, display controller ex459, modulator/demodulator ex452, multiplexer/demultiplexer ex453, audio signal processor ex454, slot ex464, and memory ex467 are connected via bus ex470.

When the user turns the power button of power supply circuit ex461 on, smartphone ex115 is powered on into an operable state by each component being supplied with power from a battery pack.

Smartphone ex115 performs processing for, for example, calling and data transmission, based on control performed by main controller ex460, which includes a CPU, ROM, and RAM. When making calls, an audio signal recorded by audio input unit ex456 is converted into a digital audio signal by audio signal processor ex454, and this is applied with spread spectrum processing by modulator/demodulator ex452 and digital-analog conversion and frequency conversion processing by transmitter/receiver ex451, and then transmitted via antenna ex450. The received data is amplified, frequency converted, and analog-digital converted, inverse spread spectrum processed by modulator/demodulator ex452, converted into an analog audio signal by audio signal processor ex454, and then output from audio output unit ex457. In data transmission mode, text, still-image, or video data is transmitted by main controller ex460 via user interface input controller ex462 as a result of operation of, for example, user interface ex466 of the main body, and similar transmission and reception processing is performed. In data transmission mode, when sending a video, still image, or video and audio, video signal processor ex455 compression encodes, via the moving picture encoding method described in the above embodiments, a video signal stored in memory ex467 or a video signal input from camera ex465, and transmits the encoded video data to multiplexer/demultiplexer ex453. Moreover, audio signal processor ex454 encodes an audio signal recorded by audio input unit ex456 while camera ex465 is capturing, for example, a video or still image, and transmits the encoded audio data to multiplexer/demultiplexer ex453. Multiplexer/demultiplexer ex453 multiplexes the encoded video data and encoded audio data using a predetermined scheme, modulates and converts the data using modulator/demodulator (modulator/demodulator circuit) ex452 and transmitter/receiver ex451, and transmits the result via antenna ex450.

When video appended in an email or a chat, or a video linked from a web page, for example, is received, in order to decode the multiplexed data received via antenna ex450, multiplexer/demultiplexer ex453 demultiplexes the multiplexed data to divide the multiplexed data into a bitstream of video data and a bitstream of audio data, supplies the encoded video data to video signal processor ex455 via synchronous bus ex470, and supplies the encoded audio data to audio signal processor ex454 via synchronous bus ex470. Video signal processor ex455 decodes the video signal using a moving picture decoding method corresponding to the moving picture encoding method described in the above embodiments, and video or a still image included in the linked moving picture file is displayed on display ex458 via display controller ex459. Moreover, audio signal processor ex454 decodes the audio signal and outputs audio from audio output unit ex457. Note that since real-time streaming is becoming more and more popular, there are instances in which reproduction of the audio may be socially inappropriate depending on the user's environment. Accordingly, as an initial value, a configuration in which only video data is reproduced, i.e., the audio signal is not reproduced, is preferable. Audio may be synchronized and reproduced only when an input, such as when the user clicks video data, is received.

Although smartphone ex115 was used in the above example, three implementations are conceivable: a transceiver terminal including both an encoding device and a decoding device; a transmitter terminal including only an encoding device; and a receiver terminal including only a decoding device. Further, in the description of the digital broadcasting system, an example is given in which multiplexed data obtained as a result of video data being multiplexed with, for example, audio data, is received or transmitted, but the multiplexed data may be video data multiplexed with data other than audio data, such as text data related to the video. Moreover, the video data itself rather than multiplexed data maybe received or transmitted.

Although main controller ex460 including a CPU is described as controlling the encoding or decoding processes, terminals often include GPUs. Accordingly, a configuration is acceptable in which a large area is processed at once by making use of the performance ability of the GPU via memory shared by the CPU and GPU or memory including an address that is managed so as to allow common usage by the CPU and GPU. This makes it possible to shorten encoding time, maintain the real-time nature of the stream, and reduce delay. In particular, processing relating to motion estimation, deblocking filtering, sample adaptive offset (SAO), and transformation/quantization can be effectively carried out by the GPU instead of the CPU in units of, for example pictures, all at once.

### INDUSTRIAL APPLICABILITY

The present disclosure is applicable to an image decoding device and an image encoding device. Specifically, the present disclosure is applicable to televisions, recorders, personal computers, digital still cameras, digital video cameras, and smartphones.

### REFERENCE MARKS IN THE DRAWINGS

100 image encoding device
101 block splitter
102 subtractor
103 transformer
104 quantizer
105 entropy encoder
106, 202 inverse quantizer
107, 203 inverse transformer
108, 204 adder
109, 205 frame memory
110, 206 predictor
111 motion detector
112, 207 motion compensator
113, 115, 208, 210 selector
114, 118, 209, 213 buffer
116, 211 controller
117, 212 predicted image generator
121 input image
122 coding block
123, 128, 224 difference block
124, 125, 127, 222, 223 coefficient block
126, 221 bitstream
129, 225 decoded block
130, 227 reference block
131, 228 reference pixel
132, 229 predicted image
133, 230 predicted block
134, 231 motion information
200 image decoding device
201 entropy decoder
226 decoded image

1. An image decoding method, comprising:
obtaining, for each of processing units obtained by splitting a current frame, motion vectors assigned to the processing unit;
selecting, for each of small regions obtained by splitting a processing unit among the processing units, a motion vector to be used from among the motion vectors assigned to the processing unit, based on the motion vectors and reference frames at different times;
generating, for each of the small regions, a predicted image using the motion vector selected for the small region; and
decoding each of the small regions using the predicted image generated for the small region.

2. The image decoding method according to claim 1, wherein
the reference frames include a first frame and a second frame, and
in selecting the motion vector,
a correlation between a region on the first frame and a region on the second frame is obtained for each of the motion vectors, the region on the first frame and the region on the second frame being indicated by the motion vector from a current small region included in the current frame, and
the motion vector to be used is selected based on the correlations obtained for the motion vectors.

3. The image decoding method according to claim 2, wherein
the motion vectors include a background vector indicating background motion, and a foreground vector indicating foreground motion.

4. The image decoding method according to claim 3, wherein
in selecting the motion vector,
the background vector is selected when a correlation between regions indicated by the background vector and a correlation between regions indicated by the foreground vector are each lower than a predetermined value.

5. The image decoding method according to claim 4, wherein
in generating the predicted image,
when the correlation between the regions indicated by the background vector and the correlation between the regions indicated by the foreground vector are each lower than the predetermined value, the predicted image is generated using a region that belongs to a background, among a first region on the first frame and a second region on the second frame, the first region and the second region being indicated by the background vector.

6. The image decoding method according to claim 5, wherein
in generating the predicted image,
one of the first region and the second region is determined to belong to the background when a corresponding point which is a region on the current frame belongs to the background, the corresponding point being indicated by the foreground vector from the one of the first region and the second region.

7. The image decoding method according to claim 5, wherein
in generating the predicted image,
when neither the first region nor the second region belongs to the background, a predicted image of a current small region within the current frame is generated using a predicted image of a region near the current small region.

8. An image encoding method, comprising:
detecting, for each of processing units obtained by splitting a current frame, motion vectors to be assigned to the processing unit;
selecting, for each of small regions obtained by splitting a processing unit among the processing units, a motion vector to be used from among the motion vectors assigned to the processing unit, based on the motion vectors and reference frames at different times;
generating, for each of the small regions, a predicted image using the motion vector selected for the small region; and
encoding each of the small regions using the predicted image generated for the small region.

9. The image encoding method according to claim 8, wherein
the reference frames include a first frame and a second frame, and
in selecting the motion vector,
a correlation between a region on the first frame and a region on the second frame is obtained for each of the motion vectors, the region on the first frame and the region on the second frame being indicated by the motion vector from a current small region included in the current frame, and
the motion vector to be used is selected based on the correlations obtained for the motion vectors.

10. The image encoding method according to claim 9, wherein
the motion vectors include a background vector indicating background motion, and a foreground vector indicating foreground motion.

11. The image encoding method according to claim 10, wherein
in selecting the motion vector,
the background vector is selected when a correlation between regions indicated by the background vector and a correlation between regions indicated by the foreground vector are each lower than a predetermined value.

12. The image encoding method according to claim 11, wherein
in generating the predicted image,
when the correlation between the regions indicated by the background vector and the correlation between the regions indicated by the foreground vector are each lower than the predetermined value, the predicted image is generated using a region that belongs to a background, among a first region on the first frame and a second region on the second frame, the first region and the second region being indicated by the background vector.

13. The image encoding method according to claim 12, wherein
in generating the predicted image,
one of the first region and the second region is determined to belong to the background when a corresponding point which is a region on the current frame belongs to the background, the corresponding point being indicated by the foreground vector from the one of the first region and the second region.

14. The image encoding method according to claim 12, wherein
in generating the predicted image,
when neither the first region nor the second region belongs to the background, a predicted image of a current small region within the current frame is generated using a predicted image of a region near the current small region.

15. An image decoding device, comprising:
processing circuitry; and
storage accessible from the processing circuitry, wherein
the processing circuitry performs the image decoding method according to claim 1, using the storage.

16. An image decoding device, comprising:
an obtainer which obtains, for each of processing units obtained by splitting a current frame, motion vectors assigned to the processing unit;
a selector which selects, for each of small regions obtained by splitting a processing unit among the processing units, a motion vector to be used from among the motion vectors assigned to the processing unit, based on the motion vectors and reference frames at different times;
a generator which generates, for each of the small regions, a predicted image using the motion vector selected for the small region; and
a decoder which decodes each of the small regions using the predicted image generated for the small region.

17. An image encoding device, comprising:
processing circuitry; and
storage accessible from the processing circuitry, wherein
the processing circuitry performs the image encoding method according to claim 8, using the storage.

18. An image encoding device, comprising:
a detector which detects, for each of processing units obtained by splitting a current frame, motion vectors to be assigned to the processing unit;
a selector which selects, for each of small regions obtained by splitting a processing unit among the processing units, a motion vector to be used from among the motion vectors assigned to the processing unit, based on the motion vectors and reference frames at different times;
a generator which generates, for each of the small regions, a predicted image using the motion vector selected for the small region; and
an encoder which encodes each of the small regions using the predicted image generated for the small region.

19. An image encoding/decoding device, comprising:
the image decoding device according to claim 15; and
an image encoding device comprising:
processing circuitry; and
storage accessible from the processing circuitry, wherein
the processing circuitry performs an image encoding method using the storage, the image encoding method comprising:
detecting, for each of processing units obtained by splitting a current frame, motion vectors to be assigned to the processing unit;
selecting, for each of small regions obtained by splitting a processing unit among the processing units, a motion vector to be used from among the motion vectors assigned to the processing unit, based on the motion vectors and reference frames at different times;
generating, for each of the small regions, a predicted image using the motion vector selected for the small region; and
encoding each of the small regions using the predicted image generated for the small region.
